(19) United States
(12) Patent Application Publication
(10) Pub. No.: US 2003/0155344 A1
(43) Pub. Date: Aug. 21, 2003

(54) Apparatus for diagnostic assays

(76) Inventor: Benjamin David Cobb, Wiltshire (GB)

Correspondence Address: Mitchell Silberberg & Knupp, 11377 West Olympic Boulevard, Los Angeles, CA, 90064, US

(21) Appl. No.: 10/343,571

(22) PCT Filed: Aug. 3, 2001
(86) PCT No.: PCT/GB01/03501

(30) Foreign Application Priority Data
Aug. 4, 2000 (GB) 0019144.5
Nov. 16, 2000 (GB) 0027993.5
Feb. 13, 2001 (GB) 0103532.8

(51) Int. Cl. F27D 11/00

(52) U.S. Cl. 219/428; 219/433; 219/521

(57) ABSTRACT

The invention relates to apparatus for diagnostic, experimental and other laboratory procedures and methods associated therewith. In particular, the invention provides a sample container for a fluid sample comprising a support, a receptacle which, together with the support, defines a sample space, and heater means affixed to said support in thermal contact with, but electrically insulated from, the sample space. The containers are particularyl suitable for use in PCR procedures.

This invention relates to apparatus for diagnostic, experimental and other laboratory procedures and methods associated therewith.

A large number of diagnostic procedures include steps in which temperature changes are effected. Tight control over the temperature of a sample is required in order to achieve reproducible and accurate results. Further, many diagnostic procedures utilise enzymes and tight thermal control is also required in order to maintain their optimal performance. Temperature tolerances in some procedures are typically of the order of ±0.2° C. The required tight temperature control generally necessitates close contact between the heating or cooling element and the sample.

A high degree of apparatus and reagent sterility is required to ensure that reliable reproducible results are obtained in diagnostic procedures. In addition, there is demand for reduced assay processing times. One of the ways in which assay processing times can be reduced whilst sterility is maintained is by the utilisation of disposable, sterile apparatus parts.

As a result of the need for close proximity between heating/cooling elements and samples, it has so far proved difficult to obtain a reliable disposable heating element at an acceptable cost. Conventional heating systems in diagnostic apparatus make use of either water heating/ cooling or Peltier blocks. The high heating rates generally required drive disposable heating elements to the limit of their operational envelopes and operational failure is very common.

One molecular application in which controlled heating is particularly important is the polymerase chain reaction (PCR). The principle of the PCR nucleic acid amplification technique is described in U.S. Pat. No. 4,683,195 (Cetus Corporation/Roche). Apparatus for carrying out the PCR reaction have been described in, for example, European Patent application EP 0 236 069 (Cetus Corporation/ Roche/PE). Such apparatus are commonly referred to as “thermocyclers”.

In a broad first aspect, the invention provides a sample container having one or more sample spaces with each of which is associated a heater means. Thus the invention provides a sample container for a fluid sample comprising a support, a receptacle which, together with the support, defines a sample space, and heater means affixed to said support in thermal contact with, but electrically insulated from, the sample space. Preferably, the sample space has a capacity of not more than 1 ml.

The invention further provides a sample container comprising a support, an array of discrete receptacles which, together with the support, defines an array of sample spaces each arranged to receive a sample of fluid, and heater means affixed to said support in thermal contact with, but electrically insulated from, the sample spaces, wherein the heater means is so arranged that it can apply to one or more sample spaces of the array heating conditions that are different from those applied to another sample space or sample spaces of the array.

In such a sample container, the heater means preferably comprises a multiplicity of heater elements. More preferably, each heater element is arranged to heat a respective individual receptacle. Preferably, each receptacle has a capacity of not more than 100 μl.

The term “receptacle” is used herein to mean a body suitable for enclosing a fluid sample. In a preferred embodiment, the receptacle takes the form of a cavity in a substantially planar body, preferably an aperture through the planar body in the direction perpendicular to the plane of that body. In the sample container, it will be appreciated that that cavity or aperture will be closed by appropriate closure means, which may comprise the support.

The heater means may be of any suitable type including an electric resistive heater.

The sample space need not be defined by the support and the receptacle only. The sample space may be defined by the support, the receptacle and a further enclosing member. The support may optionally be covered with a coating layer, for example an electrically insulating layer. For the avoidance of doubt, where such a layer is present, the support is nonetheless to be considered as defining the sample space.

The invention offers the possibility of a relatively simple and inexpensive container which may be disposable, and which is suitable for use in molecular diagnostics applications, clinical analysis or other analysis applications or chemical or biochemical synthesis applications. The containers of the invention are particularly suitable for use in PCR applications. Other applications in which the containers of the invention offer particular advantages are synthesis applications, restriction digestion procedures, sequencing procedures, ligation procedures and DNA or RNA sizing procedures.

Containers of the current invention are preferably provided with electric resistive heater means. Preferably, the or each heater is applied onto the support. The electric resistive heater means is advantageously directly or indirectly printed onto the support, for example, it may be screen-printed onto the support. Alternatively, the heater means may be defined by chemical etching, thin film deposition, pure metal deposition or photolithography, photolithography being particularly suitable for heater means involving resolution smaller than 0.1 mm. A screen printed heating element may be constructed using one or more conducting inks. Preferably the ink comprises a conductive component which may be selected from carbon, gold or silver. Suitable inks are, for example, obtainable from Acheson Colloiden B. V., the Netherlands or from Poly-Flex Ltd, Isle of Wight, U.K..

Screen printing is a particularly advantageous means of applying the heater means as it enables a multiplicity of heating elements and associated circuitry to be applied to the support especially efficiently and precisely but on a relatively small scale (typically, the heating elements may be less than 0.5 cm in cross-section). In use, a small heater heats predominantly the sample of interest without heating a large amount of the surrounding apparatus. This brings about particularly efficient heating. Screen printing inks of a conventional type may be used. As already mentioned, an ink comprising carbon, gold or silver is suitable. Different inks and/or different thicknesses of ink may be used for different portions of the circuitry to adjust the circuit properties appropriately. For example, a thin layer of low conductivity ink may be used for a heater element, giving rise to heat emission at that position in the circuit. Analogously, a thick layer of high conductivity ink may be used for electrical connection portions of a circuit so as to minimise heat emissions at those positions in the circuit.

Conventional heated reaction containers have generally been heated and cooled using a supply of heated water or a Peltier Block. Neither of those heating arrangements allows a small reaction vessel to be heated as efficiently as the resistive heaters in accordance with the invention. Typically, a Peltier block has a power requirement of 100-500 W, whilst the screen-printed electric resistive heaters in accordance with the invention typically have a power requirement of less than 10 W. The heater element geometry in a container in accordance with the current invention may be adapted according to the shape of the vessel and the rate at which the samples are to be heated, also known as the temperature ramp rate.

In most diagnostic or experimental sample heaters of the prior art, a sample is heated in a disposable container, which container is brought into contact with the heater for heating and is removed from the heater and disposed of after use. The heater accordingly provides heat to a space in which there is a sample in a container. The invention offers the possibility of a heater sample container in which the heater provides heat to a space in which there is a sample directly, without the need for a further container.

In WO 98/24548 there is disclosed a reagent vessel comprising an electrically conducting polymer capable of emitting heat when an electric current is passed through it. In one embodiment, the vessel is a box comprising a plurality of receptor bays, each bay comprising a polymer heater sheath with electrical connections such as to permit different power supplies to each of the receptor bays. Separate tubes containing the samples are provided for introduction into the bays.

The heater means is applied onto a support, suitably a substantially flat support, preferably a film support. If the film is substantially planar, the application of the heater means is facilitated. The film support, which may be flexible, should be resistant to water and to reagents that are commonly used in the assays or other applications and heat-resistant up to typical operating temperatures. It will be appreciated that, where the heater means is to be applied by printing, the film support should be receptive to printed inks. Preferably, the film support is a thermal insulator. Suitable films include those of materials that inherently possess the desired properties and those of materials that do not inherently possess those properties but which are rendered suitable by appropriate treatment. Examples of suitable films include (optionally treated) acetate, polyester and polyimide films (such as that available under the trade name Kapton (RTM)). An especially suitable film is a polyester sheet. Such sheets are available, for example, from Autotype International Ltd., U.K. under the trade name Autostart. Preferably the support comprises a polymeric film material. Films have the advantage that they are thinner than conventional printed circuit board backing supports and that they may be water-resistant. In some applications, suitably treated paper may be a suitable support.

Most conventional polyester sheets are not sufficiently heat resistant to support a screen-printed heater. Appropriate treatment, for example, UV-curing, of the polyester sheet may be necessary to ensure that the sheet has the required properties.

Preferably the heating element or elements are coated with a passivator layer which electrically insulates the sample space from the heater itself. The passivator layer is preferably thermally conducting and electrically insulating. The passivator layer may be made of a dielectric ink. Dielectric inks are well-known, and any suitable dielectric ink may be used. Suitable dielectric inks are available, for example, from Poly-Flex Circuits Ltd., Isle of Wight, U.K..

Preferably the support is of a laminar configuration. The or each sample space is preferably formed from at least three cooperating members, comprising a first member having a substantially flat surface comprising a heating element, a second member being a layer having an aperture defining a void or a plurality of apertures defining a plurality of voids and a third member having a substantially flat surface. The members are preferably held in contact with each other by a suitable adhesive, for example a tape coated with adhesive on both sides, as available for example from Avery Dennison, Specialty Tape Division, Belgium. The walls and other structural components of the receptacles will generally form a part of the second member and are preferably constructed from materials which are water- and reagent-resistant and heat-resistant up to typical operating temperatures. Preferably, the materials are thermal insulators. They may of any kind that is suitable for forming the desired structures and which has the desired properties in use of the container. Injection moldable materials are particularly suitable. Examples of suitable materials include polycarbonates and acrylonitrile-butadiene-styrene polymers. Suitable materials are available for example from Dow Plastics, Horgen, Switzerland.

Preferably, the or each sample space has an arcuate shape viewed perpendicular to the plane of the support defined by an arcuate wall Preferably, the arcuate sample space has a width such that the meniscus of a body of the sample fluid (for example water) can simultaneously contact the wall on both sides of the sample space when entering the sample space. The arcuate shape (or kidney shape) and the appropriate width enable fluid to enter the sample space as a single front in a horizontal direction rather than from the bottom to the top. That filling mechanism reduces the formation of bubbles in the sample in the sample space.

The container of the invention preferably comprises an access tube for the deposit of samples in the or each sample space. The container may advantageously comprise a vent to avoid air pressure build up in the receptacle(s) preventing sample deposition. The access tube may communicate with the respective sample space by means of a gap between the first member (having the substantially flat surface comprising a heating element) and the second member (the layer having an aperture defining a void or a plurality of voids) or a gap between the second member (the layer having an aperture defining a void or a plurality of voids) and the substantially flat surface of the third member. Preferably, the sample space(s) can be sealed after a sample has been deposited. The sealing may be effected by pressing together the layers of the receptacle such that the gap between layers is closed.

Preferably, the sample container of the invention is detachable from a power- and control-supplying means.

Particularly in molecular diagnostics applications, it is common for a plurality of experiments to be carried out simultaneously. In such circumstances, it may be advantageous for a container to have a plurality of receptacles.

As mentioned above, it may be advantageous for a multiplicity of receptacles to be provided in an array or matrix. In such a receptacle array or matrix, it is convenient to screen print a plurality of heater elements onto the same substantially flat support, each heater element heating its own sample space. The support is advantageously sufficiently thermally insulating so as not to allow significant flow of heat from one heated container to another.

Preferably, the sample container comprises an array of receptacles, each arranged to receive a sample of fluid, wherein the heater means is so arranged that it can apply to one or more sample spaces of the array heating conditions that are different from those applied to another sample space or sample spaces of the array.

Whilst the container of the invention may be used with any size of sample, it is most suited to the heating of samples of not more than 1 ml in volume. Accordingly, the or each sample space of the container of the invention may have a capacity of not more than 1 ml. Advantageously, the or each sample space has a capacity of not more than 250 μl. For example, the or each sample space has a capacity of not more than 100 μl. In an array arrangement, the individual sample spaces of the container of the invention preferably each have a capacity of not more than 100 μl. Preferably, each of the sample spaces has a capacity of not more than 50 μl, more preferably not more than 30 μl. Typically each of the sample spaces has a capacity of 20 μl. In practice, each sample space will have a capacity of at least 0.5 μl.

The containers of the invention are preferably disposable. This requires that the container is detachable from a power- and control-supplying means and makes it preferable that the materials from which it is made may be incinerated with normal laboratory waste. Further, the device is preferably sufficiently economical to manufacture that it can be produced at a cost which is acceptable for a disposable element.

Optionally, the device may comprise means for detecting the conductivity of the sample in a receptacle. For example, the conductivity detecting means may be on a surface of the receptacle facing the surface to which the heating means is affixed. The conductivity detecting means may comprise a circuit produced in an analogous fashion to the heating element circuit. It may be screen printed and the materials used for its construction may fulfil the same criteria as those from which the heating means may be constructed.

Optionally, the container of the invention may comprise temperature sensing means. The temperature sensing means may be in direct contact with the sample or it may be only in thermal contact with the sample. For example, it may be on the other face of the support to which is attached the conductivity detecting means. In use, the temperature sensing means may measure the temperature of the sample and allow the supply of heat to the sample to be varied according to the sample temperature required.

The invention further provides a sample container for a fluid sample comprising a receptacle defining a sample space, a support and screen printed heater means affixed to said support in thermal contact with, but electrically insulated from the sample space. Such a sample container may have any of, or any combination of, the additional features discussed above.

The invention also provides sample container for a fluid sample comprising a support, means defining a sample space on the support and heater means affixed to the support in thermal contact with the sample space wherein the means defining the sample space, the support and the heater means form an integrated unit. The means defining the sample space may be an aperture in a substantially planar body, a wall or a plurality of walls or any other structure suitable for enclosing a sample. Such a sample container may have any of, or any combination of the additional features discussed above.

The invention further provides a sample container for a fluid sample comprising a substantially planar body defining at least one sample space in said body and heater means integrated within said body, the heater means being in thermal contact with the sample space. Such a sample container may have any of, or any combination of, the additional features discussed above.

The invention further provides an apparatus comprising a sample container according to the invention and control means which controls the heater means of the sample container. Preferably, the control means is arranged to control the heating means in dependence on measured values of sample temperature. Preferably the control means is a computer.

In a preferred embodiment, the control means controls the supply of current to the heater means. A temperature monitoring sensor may be present near the sample which feeds back temperature information to the control means, which may be arranged to adjust the power supply to the heater means. Preferably the power supply to the heater means is controlled by computing means.

The invention further provides an apparatus comprising a sample container according to the invention having a multiplicity of sample spaces, each associated with a respective heater element, the control means being arranged to control each heater element individually in dependence upon a value related to temperature generated from temperature sensing means associated with the corresponding sample space.

The invention further provides a holder that may supply power and control to a sample container in accordance with the invention and from which the sample container may be detachable.

Optionally, the apparatus or holder according to the invention may comprise fluorescence or UV-visible absorption detection means for obtaining fluorescence or UV-visible information regarding a sample.

The light source may be of a type known in the art. Suitable light sources include Light Emitting Diodes (LEDs), lasers and conventional bulbs, including halogen bulbs. The light source may produce light of a single wavelength, of a number of single wavelengths or of a mixture of wavelengths.

The detector means may be of a type known in the art. Suitable detectors include charge-coupled devices (CCDs) and arrays of CCDs. If more than one wavelength of light is used or is to be detected, it may be desirable for the detector means to include a demultiplexer to separate different wavelengths of light for detection.

A container for use with an apparatus or holder according to the invention comprising fluorescence or UV-visible absorption detection means is preferably arranged such that the electrically resistive element does not impede the path of the source light or the emitted/transmitted light.

Fluorescence-based approaches to real-time measurement of PCR amplification products have been proposed and are in common usage. Some such approaches have employed double-stranded DNA binding dyes (for example fluorescein as used in the SYBR Green I (RTM) system or intercalating dyes such as ethidium bromide) to indicate the amount of double stranded DNA present. Other approaches have employed probes containing fluorescer-quencher pairs (for example the “TaqMan” (RTM) approach) that are cleaved during amplification to release a fluorescent product the concentration of which is indicative of the amount of double stranded DNA present. Adaptations of those approaches are known (as described in, for example, WO 95/30139), in which two or more dyes are used.

The apparatus or holder of the invention is particularly suitable for use with the above-mentioned fluorescence systems. Commonly used emission wavelengths include 530 nm (fluorescein), 640 nm (LC Red 640) and 710 nm (LC Red 705).

It is also common to detect the presence of a particular amplification product by means of hybridisation probes. Such probes may be provided with fluorescent dyes with a variety of emission characteristics and, in a given experiment, it may be desirable to use more than one dye. The apparatus of the invention is also suitable for use in such detection systems. The ability to analyse a plurality of wavelengths of light without the need for moving parts is particularly advantageous for such applications.

The invention further provides the use of a sample container according to the invention for heating a fluid sample. The invention also provides a method of heating a multiplicity of fluid samples in a multiplicity of discrete receptacles provided on a common support wherein one or more samples are heated differently from another sample or other samples. Preferably, said one or more samples are heated to a different temperature from said other sample(s). Advantageously, said one or more samples are heated at a different rate from said other sample(s). In a preferred embodiment, the heating is pulsed. Whilst pulsed heating has been found to give certain advantages, it will be appreciated that any suitable form of power supply may be used with the containers of the invention, for example, a variable current supply.

A large number of diagnostic procedures are carried out on fluid samples, or include steps involving fluid reagents. Such procedures are commonly carried out in a receptacle for the sample. It is highly preferable that fluid reagents and the sample are securely contained and sealed within the receptacle such that they cannot escape.

Leakage of fluid from a receptacle can cause a hazard to operating staff and to equipment and may cause data obtained from an assay to be unreliable. A high degree of apparatus and reagent sterility is required to ensure that reliable reproducible results are obtained in diagnostic procedures. Adequate sealing of a sample receptacle is necessary to achieve this end. Containment of fluid within a receptacle is particularly important and can be difficult to achieve in procedures in which a sample is heated and/or cooled.

In a second aspect of the invention, there is provided a sample container for a fluid sample comprising a first portion and a second portion, a receptacle defining a sample space located between the first portion and the second portion, an access tube for depositing a sample in the sample space, and a communication channel through which the access tube communicates with the sample space, wherein the container is deformable such that the application of pressure pressing the first portion and the second portion together causes the communication channel to be closed. Preferably, the sample space has a capacity of not more than 1 ml.

The first portion and the second portion of the sample container may be individual members (as in, for example, a laminar arrangement) or they may be portions of a single structural element (as in, for example, a molded container). When it is open, the communication channel serves to allow deposition of a sample in the receptacle. The channel may be so sized that capillary action aids the movement of sample fluid from the access tube to the receptacle. When the communication channel is closed, the sample space is sealed such that fluid communication between the access tube and the receptacle is hindered.

This second aspect of the invention offers the possibility of a container with no moving parts. Accordingly, the possibility is offered of a relatively simple and inexpensive container which may be disposable, which is suitable for use in molecular diagnostics applications, clinical analysis or other analysis applications or chemical or biochemical synthesis applications. The containers of the invention are particularly suitable for use in PCR applications. Other applications in which the containers of the invention offer particular advantages are synthesis applications, restriction digestion procedures, sequencing procedures, ligation procedures and DNA or RNA sizing procedures.

This second aspect of the invention further provides a sample container comprising a first portion and a second portion, an array of discrete receptacles, each receptacle defining a sample space located between the first portion and the second portion and being arranged to receive a sample of fluid, an access tube associated with each sample space for depositing a sample in the sample space and a communication channel associated with each sample space through which each access tube communicates with its associated sample space, wherein the container is deformable such that the application of pressure pressing the first portion and the second portion together causes the communication channels to be closed. Preferably each sample space has a capacity of not more than 100 μl.

The preferred capacities indicated above in relation to the containers of the first aspect of the invention apply also to the or each sample space of the container of this second aspect of the invention.

Preferably the container in accordance with the second aspect of the invention is resiliently deformable, such that the communication channel opens when the pressure is removed. This offers the possibility of removing a portion of fluid from a receptacle after a first closure. It also offers the possibility of depositing further sample or further reagent in a receptacle after a first closure.

Preferably, the or each receptacle in a container according to the second aspect of the invention further comprises a vent hole. The vent hole serves to allow air to escape from the receptacle when fluid is deposited in the receptacle so as to avoid the build up of air pressure in the receptacle. The vent hole is preferably sealable. Preferably, the vent hole can be sealed before or during the process in which the communication channel is closed. Preferably, the vent hole is sealable by means of deformation, especially resilient deformation of the container. Thus, a preferred form of container is so deformable that, on deformation in response to a force applied to the container, the communication channel and a vent hole are sealed. An especially preferred form of container is resiliently deformable such that, on removal of said force, the communication channel and/or the vent hole can re-open.

Containers of the second aspect of the invention preferably comprise a heating element associated with the or each sample space. The heating element serves to control the temperature of the fluid in a receptacle. In an array of discrete receptacles, preferably each receptacle comprises an individual heating element. The heating element may incorporate any of the features discussed above in relation to the heater means suitable for use in the first aspect of the invention.

The or each sample space is preferably formed from at least three cooperating members, comprising a first member having a substantially flat surface, a second member having an aperture defining a void or a plurality of voids each with an associated access tube and a communication channel through which the access tube communicates with the void, and a third member having a substantially flat surface, wherein the second layer is made of a resiliently deformable material such that the application of pressure pressing the first and third members together causes the or each communication channel to be closed. That construction offers the possibility of container which is straightforward to construct. Preferably the communication channel is located between the first member and the second member or between the second member and the third member.

The invention further provides in a third aspect a holder for a sample container, the sample container having at least first and second outer surfaces at least one of which has at least one access opening for the introduction of material into the container, the holder comprising a first plate and a second plate, said first and second plates being movable relative to one another between a first, open position and a second, closed position, the plates being so dimensioned and configured that in the closed position they can press against, respectively, said first and second outer surfaces of a said container and can cause the at least one access opening to be closed.

The holder in accordance with the second aspect of the invention offers the possibility of securely sealing a sample receptacle or a container in a rapid and unlaborious fashion. The holder further enables a multiplicity of sample receptacles to be sealed simultaneously and securely.

Preferably, at least one of the plates is made of a thermally conducting material and is arranged to have an area of contact with a portion of the container adjacent a sample space so as to serve as a heat sink from the sample space. The area of contact with the portion of the container is preferably of a shape and configuration to correspond with a sample space in the container. Preferably, the plate contacts more than 50% of the container surface adjacent to a sample space; more preferably, the plate contacts more than 80% of the container surface adjacent to a sample space; still more preferably, the plate contacts more than 95% of the container surface adjacent to a sample space.

Preferably, one of the plates comprises a nodule or nodules arranged to correspond with an or each sample receptacle of said container, the or each nodule being so positioned that it can apply pressure to the first or second outer surfaces of the container adjacent to the or each sample receptacle, thereby assisting in closing the access opening. The or each access opening is generally only in a specific location on the sample container. Accordingly, it may be advantageous to direct pressure to effect the closure of the access openings to particular positions on the surface of the container. This is conveniently achieved by the presence of nodules on one or both of the plates.

The apparatus may be arranged such that one plate is arranged to be stationary and the other plate is moveable relative thereto. Preferably, the plate that is moveable is pivotable about a hinge. In that arrangement, there are relatively few moving parts and a simple construction is effective.

Alternatively, the apparatus may be arranged such that both of the plates are moveable relative to the space for receiving a sample container. Preferably, each plate is independently pivotable about a respective hinge. Each plate may be rotatably mounted on a respective rod, the rods being substantially parallel to each other. In an arrangement comprising only a single hinge, there is a risk that the sample container is compressed unevenly. Generally, that arrangement results in the portion of the sample container nearest to the hinge being compressed most. In the arrangement in which both of the plates are movable relative to the space for receiving the sample container, the sample container is holdable between the two plates in a “floating” position and a small amount of movement of the plates relative to each other is possible without the pressure on the sample container being reduced. This facility maintains an even distribution of pressure over the sample holder surfaces.

Advantageously, the apparatus comprises a motor which serves to move the plates relative to each other. Preferably each plate is pivotable about a respective hinge and a communicating member projects from each plate to the other side of the hinge, and the motor comprises a drive member which, upon rotation, presses against the communicating members and moves the plates towards each other. The drive member is advantageously ovoid in shape such that the radial displacement of its outer surface varies around its axis. The communicating members projecting from the respective plates contact the drive member and they are separated from each other by a distance dictated by the drive member. Accordingly, in a first position, the radial displacement of the drive member is relatively small and a relatively small distance separates the two communicating members. By action of the motor, the drive member rotates to a second position in which its radial displacement is greater. In the second position, a larger distance separates the two communicating members and the plates, being attached to the communicating members, are pressed together.

The invention relates to temperature-controlling methods for diagnostic, experimental and other laboratory procedures and apparatus associated therewith.

Conventionally, heating of a fluid is carried out by use of a heater in thermal contact with the fluid. If thermostatic heating is desired, a further apparatus component, a temperature sensor, is required. In use, a desired target temperature is communicated to a control means. The temperature sensor feeds back information relating to the temperature of the fluid to the control means and the rate of heating is adjusted appropriately such that the desired temperature is achieved. In such an apparatus, it is necessary to use two circuits.

According to a third aspect, the invention provides a method of heating a fluid sample wherein a voltage is applied across, or a current is supplied to, an electrically resistive element in such a fashion that the electrically resistive element serves as a heater in a first period and serves as temperature sensing means in a second period.

Particularly in molecular diagnostics applications, it is common for a plurality of experiments to be carried out simultaneously. In such circumstances, it may be advantageous for a plurality of samples to be heated at the same time. Accordingly the third aspect of the invention provides a method of heating a plurality of fluid samples wherein a voltage is applied across, or a current is supplied to, each of a plurality of electrically resistive elements in such a fashion that each electrically resistive element serves as a heater of a sample in a first period and serves as temperature sensing means of a sample in a second period.

Preferably, each of the plurality of fluid samples is heated independently.

It will be understood that a voltage applied across an electrically resistive element will cause a current to flow through the element and, similarly, that a current supplied through an electrically resistive element will cause a potential difference to be set up between its ends. It is possible to apply a known voltage or to supply a known current.

The voltage applied across, or the current supplied through, the electrically resistive element is effectively pulsed between a heating level and a temperature measuring level. In use, pulsed heating of a sample may be carried out by a variable voltage supply (i.e. pulse width modulation), which may take any suitable form, including sinusoidal, square wave, parabolic, triangular or combinations thereof. Preferably, the voltage supply has a slew rate limited square wave profile.

Heating current I_{H} is supplied to the sample for a period of time t_{H} and temperature measuring current I_{T} is supplied for a period of time t_{T}. Preferably, t_{H} is in the range 0.1 msec to 100 sec. More preferably, t_{H} is in the range 0.2 msec to 1 sec. Still more preferably, t_{H} is in the range 1 msec to 100 msec, for example of the order of 3 msec to 50 msec. Preferably, t_{T} is in the range 0.1 msec to 100 sec. More preferably, t_{T} is in the range 0.2 msec to 1 sec. Still more preferably, t_{T} is in the range 1 msec to 100 msec, for example of the order of 3 msec to 50 msec.

The exact values for I_{H}, t_{H} and t_{T} depend on the properties of the electrically resistive element and the temperature that the sample is to attain. For a given desired temperature, a previously empirically established set of values t_{H} and t_{T} and I_{H} may be used for the supply of current to the sample. The heating current I_{H} and the temperature measuring current I_{T} may be a.c. or d.c.. I_{T} is preferably set to be sufficiently small that it causes only negligible heating of the resistive element. I_{H} is greater than I_{T}. Preferably, I_{H} is more than ten times greater than I_{T}.

The method of the invention accordingly offers the possibility of monitoring the temperature of a sample during heating, cooling or stable temperature maintenance in real time using only a single circuit for heating and for temperature measurement.

For accurate temperature control, measurements of a parameter related to the temperature of a respective resistive element may be used to feed back information relating to the actual temperature of the sample at a particular time to the control means and the control means may adjust I_{H}, t_{H} and t_{T} so as to heat the sample to the desired temperature. Preferably I_{H} is adjusted. Preferably, information from the temperature sensing means in the second period is used by the control means to adjust the voltage applied across, or the current supplied to, the or each electrically resistive element during the first period. Preferably, the temperature measurement is carried out by measurement of the resistance of the or each electrically resistive element during the second period.

In some applications, it may be desirable for the pitch of the heating cycle to be kept constant (i.e. t_{H}+t_{T}=constant) so that an increase in t_{H} is accompanied by a decrease in t_{T} and vice versa. In other applications, it may be preferable for t_{T} to be kept to a minimum, so that the circuit heats for as high a proportion of the total time as possible. In many applications, it may not actually be necessary to calculate the temperature of the electrically resistive element or of the sample. The measured resistance of the electrically resistive element is related to the temperature of the element and the temperature of the sample and, in many circumstances, the resistance information may be used directly without a calculation to a temperature reading being necessary.

The temperature of a sample is preferably assessed by measuring the temperature of the or each associated electrically resistive element during the temperature measuring period t_{T}. The temperature of the or each electrically resistive element may be determined by measuring its resistance and calculating the temperature from the measured resistance. Because of circuitry limitations, the actual measured resistance may in practice include the resistance of circuit parts other than the electrically resistive element. Those additional parts generally remain at a constant temperature and they thus have a resistance which does not vary materially with the temperature of the sample. Accordingly variations in the measured circuit resistance are indicative of variations in the resistance of the electrically resistive element and hence of variations in the temperature of the electrically resistive element.

The resistance (R) of a resistor is related to the voltage (V) applied across it and the current (I) by the relationship V=IR. The resistance of the electrically resistive element may be measured by applying a known voltage across the element and measuring the resulting current. Alternatively, and preferably, the resistance of the electrically resistive element is measured by supplying a known current through the electrically resistive element and measuring the voltage developed across it.

Before resistance measurements may be used to determine the temperature of the electrically resistive element and thus of a sample, it is generally necessary to measure a calibration curve relating the resistance of the circuit to temperature of the electrically resistive element. Accordingly the relationship of the resistance of the or each electrically resistive element circuit to the temperature of a sample is derived preferably derived by calibration measurements of resistance of the electrically resistive element at a plurality of temperatures. In apparatus of this type it is not generally economically viable to create affordable circuits with sufficiently predictable resistance to enable accurate temperature determinations without the need for calibration. More accurate manufacturing methods would make such circuits feasible.

The electrically resistive element may comprise a metal, a semi-conductor material, a conductive polymer or any other suitable material or combinations thereof. It may have any one or more of the features described above in relation to the first and second aspects of the invention.

In practice, many metallic resistors have a variation of resistance with temperature which is approximately linear in the relevant temperature range (typically approximately 25 to 100 deg. C.) and accordingly, a sufficiently accurate temperature—resistance calibration relationship may be obtainable from two calibration points, i.e. measurements of the resistance of the circuit at two different temperatures. In this manner, the absolute resistance and the rate of variation of resistance with temperature may be taken into account. For electrically resistive elements that do not have a linear resistance variation with temperature more calibration points may be necessary.

In a Peltier effect heat pump heat is absorbed at one end of the device and rejected at the other end. Such devices are commonly used in temperature-controlling diagnostic apparatus. Whilst a significant proportion of the heating by a Peltier heat pump is not strictly speaking resistive heating, such a device does have a resistance. The total resistance of a Peltier device has a variation with temperature and accordingly, a Peltier device may be used as the electrically resistive heater in accordance with the present invention.

The electrically resistive element is in close thermal contact with the sample. During the heating period, the element is supplied with current I_{H} and it becomes hot as a result of resistive or other forms of heating. A portion of the heat is transferred to the sample. Once heater current I_{H} supply stops at the end of the heating period, the element remains warmer than its surroundings, including the sample. As a result of the close thermal contact between the electrically resistive element and the sample, the element cools towards the temperature of the sample (heating the sample in the process) during the temperature measuring period.

Preferably the or each temperature determination relating to a resistive element is carried out after a delay following the end of the first period so that the temperature determination is a true assessment of the temperature of the respective sample. Preferably the thermal contact between the sample and the electrically resistive element is sufficiently efficient for them to essentially equilibrate thermally within 250 ms. More preferably the thermal contact between the sample and the electrically resistive element is sufficiently efficient for them to essentially equilibrate thermally within 50 ms. Still more preferably the thermal contact between the sample and the electrically resistive element is sufficiently efficient for them to essentially equilibrate thermally within 10 ms. Accordingly, a resistance measurement taken after that period allows the determination of a temperature for the electrically resistive element that is an accurate indication of the temperature of the sample. The temperature determination is carried out during the temperature measuring period, so the delay before taking a temperature reading must be shorter than the length of the temperature measuring period t_{T}.

If the thermal equilibration between the electrically resistive element and the sample is too slow for the required length of the temperature measuring period, a number of resistance readings may be taken during the cooling of the electrically resistive element. As it cools, the electrically resistive element approaches the equilibrium temperature in an exponentially decreasing manner. As the exponential decay of the temperature is predictable, it is possible to calculate the temperature towards which the electrically resistive element is converging from the cooling curve during the initial phase of cooling. The shape of the curve indicates the proximity of a given point on the curve to equilibrium and, given the temperature at that point on the curve, the equilibrium temperature may be calculated. Accordingly, the temperature of the or each sample may be determined by an estimation from the cooling curve of the electrically resistive element after the end of the first period. In some circumstances, the cooling curve shape may not be a mathematical exponential decay by virtue of apparatus artefacts. By use of a suitable calibration experiment, such artefacts can be taken into account.

Depending on the mode of manufacture of the electrically resistive element, the resistance of the element may vary with age and/or degree of use. In the case of screen printed metal ink circuits, it has generally been found, however, that the resistance of an element attains a substantially constant level after a period at an elevated temperature, for example 2000 minutes at 99 degrees C. Such “curing” of the electrically resistive element may be carried out with the heat being supplied by the electrically resistive element itself or by external means. The duration and magnitude of heating required for effective curing in a particular case generally depends on the size and shape of the element, its mode of manufacture and the materials from which it is manufactured.

Whilst the methods of the third aspect of the invention may be used with any size of sample, they are most suited to the heating of samples of not more than 1 ml in volume. The or each receiving space or receptacle may have a capacity indicated above in relation to the receptacles of the first or second aspects of the invention.

The methods of the third aspect of the invention are particularly suitable for use in PCR applications. Other applications in which the methods of the invention offer particular advantages are synthesis applications, restriction digestion procedures, sequencing procedures, ligation procedures and DNA or RNA sizing procedures.

It has been found that the lifetime of heater elements used in containers of the first and second aspects of the invention above can be extended and that the temperature of the fluid can be caused to be more stable over time by the use of pulsed heating. Pulsed heating may be in the form of a square wave of energy supply. High current is supplied for a period of time T_{H} and a low current (or no current) is supplied for a period of time T_{L}, the difference between high current value and the low current value defining an amplitude A. The values of T_{H}, T_{L} and A for a given sample dictate the temperature that the sample attains. For a given desired temperature, a previously empirically established set of values T_{H}, T_{L} and A may be used for the supply of heat to the sample. If this set up is used, predetermined parameters T_{H}, T_{L} and A required to obtain a given sample temperature are preferably stored in the memory of the computer or on some other computer-readable medium. The values can be drawn from the memory by the software when the user of the machine selects a particular temperature value. Generally, T_{H} is in the range 1 msec to 1 sec, for example, of the order of 10 msec. Generally, T_{L} is in the range 1 msec to 1 sec, for example, of the order of 10 msec. Generally, the applied voltage is in the range 0.1 V to 7 V, and may for example be of the order of 5 V. In practice, TTL (transistor-transistor logic) pulsing and PID (proportional integral and derivative) pulsing have been found to give especially satisfactory results.

Preferably there is used in the method a sample container according to the first or second aspects of the invention.

The invention also provides a computer program product so arranged as to cause a computer to implement a method according to the invention.

The third aspect of the invention further provides a computer program product which causes a computer so to operate:

that it takes as an input a data set signal representing a desired profile of temperature for a fluid sample with time and an input data set signal representing the temperature of the fluid sample, and

that it converts the data set signals into an output signal that represents a duration and magnitude of voltage to be applied across, or a current to be supplied to, an electrically resistive element to heat the fluid sample,

wherein a control means is instructed to apply a voltage across, or supply a current to, the electrically resistive element in a first period and the input data set signal representing the temperature of the fluid sample is provided by the same electrically resistive element during a second period.

The computer program product of the third aspect of the invention may be used with a standard computer. The profile of temperature variation for the fluid sample with time may be established by an operator. For a culture or a synthesis application, a constant temperature for a prolonged period may be desirable. For procedures involving denaturation of nucleic acids or protein, an increase of temperature with time may be required. In a PCR protocol a series of heating and cooling cycles is generally used.

The data set signal representing the temperature of the fluid sample may be obtained by the measurement of the resistance of the electrically resistive element circuit.

The third aspect of the invention further provides apparatus for heating a fluid sample comprising a receiving space for receiving a sample, an electrically resistive element and control means wherein the control means is operable so as to apply a voltage across, or supply current to, the electrically resistive element in such a fashion that the electrically resistive element may serve as a heater in a first period and may serve as temperature sensing means in a second period.

Preferably the apparatus according to the invention is suitable for heating a plurality of fluid samples.

The apparatus may be arranged to receive a sample directly in the receiving space. In such an arrangement the electrically resistive element is preferably electrically insulated from the receiving space.

Preferably, the apparatus is arranged such that the receiving space for receiving a sample comprises a space for a sample container. Such an arrangement is convenient for use in applications in which a high degree of reagent sterility is required as it allows the sample to be contained in a sterile, possibly disposable container. The containers for use in association with the apparatus of the invention may be of a standard type, for example an Eppendorf tube. Preferably, the sample container comprises an array of discrete receptacles.

For some applications, it may be preferable for the electrically resistive element to be attached to the sample container or each sample container. Accordingly, the third aspect of the invention further provides a holder for a sample container for a fluid sample, which container comprises a support, a receptacle which, together with the support, defines a sample space, and heater means affixed to said support, said holder comprising control means operable so as to apply a voltage across, or supply current to, the electrically resistive element in such a fashion that the electrically resistive element may serve as a heater in a first period and may serve as temperature sensing means in a second period.

The invention further provides a holder wherein the container comprises a support, an array of discrete receptacles which, together with the support defines an array of sample spaces each arranged to receive a sample of fluid, and heater means affixed to said support, wherein said holder comprises control means operable so as to apply a voltage across, or supply current to, the or each electrically resistive element in such a fashion that the or each electrically resistive element may serve as a heater in a first period and may serve as temperature sensing means in a second period.

Preferably, the control means and the or each electrically resistive element are so arranged that the element(s) may apply to one or more receptacles of the array heating conditions that are different from those applied to another receptacle or receptacles of the array.

In such a sample container, there are preferably a multiplicity of electrically resistive elements and the holder comprises a multiplicity of connectors to the elements.

More preferably, each electrically resistive element is arranged to heat a respective individual sample space.

The invention further provides a holder as described above in conjunction with a suitable container.

The invention offers the possibility of a relatively simple and inexpensive apparatus or holder which is suitable for use in molecular diagnostics applications, clinical analysis or other analysis applications or chemical or biochemical synthesis applications. The apparatus or holder of the invention enables close monitoring of the temperature of a sample, but it does not require separate heating and temperature measuring circuits.

Whilst the apparatus or holder of the invention may be used with any size of sample, it is most suited to the heating of samples of not more than 1 ml in volume. The or each receiving space or receptacle may have a capacity indicated above in relation to the sample spaces of the first or second aspects of the invention.

The apparatus and holder of the invention are particularly suitable for use in PCR applications. Other applications in which the holder of the invention in conjunction with a suitable container offers particular advantages are synthesis applications, restriction digestion procedures, sequencing procedures, ligation procedures and DNA or RNA sizing procedures.

In a preferred embodiment of the container for use in conjunction with the holder of the invention, is a container as described above in relation to the containers of the first or second aspects of the invention.

Certain embodiments of the invention will now be described in more detail with reference to the accompanying figures in which:

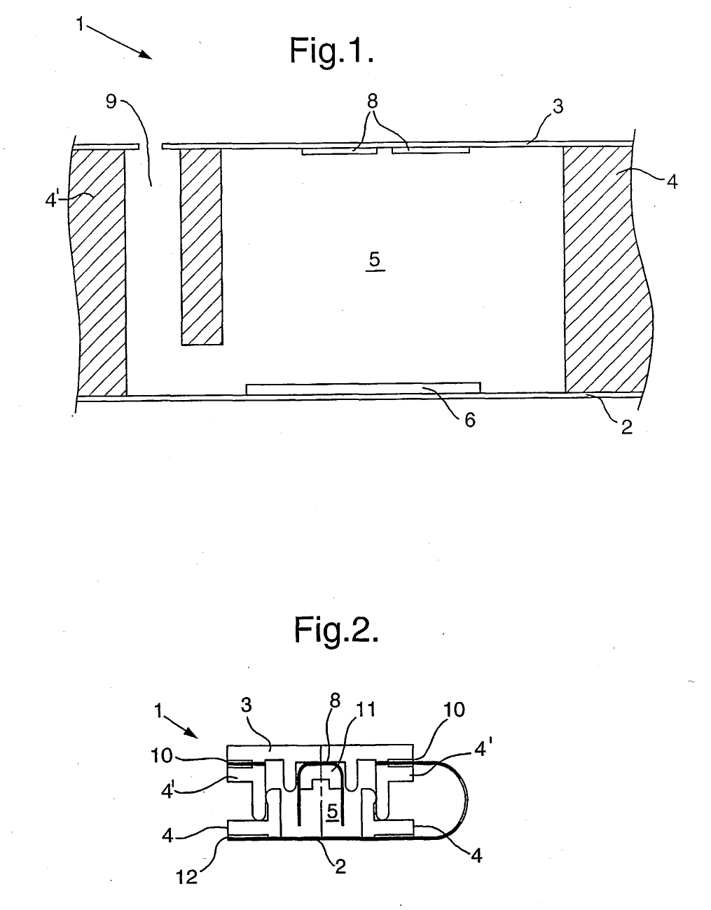

FIG. 1 is a schematic cross section of a container according to the invention suitable for a single sample;

FIG. 2 is a cross section of an embodiment of a container according to the invention;

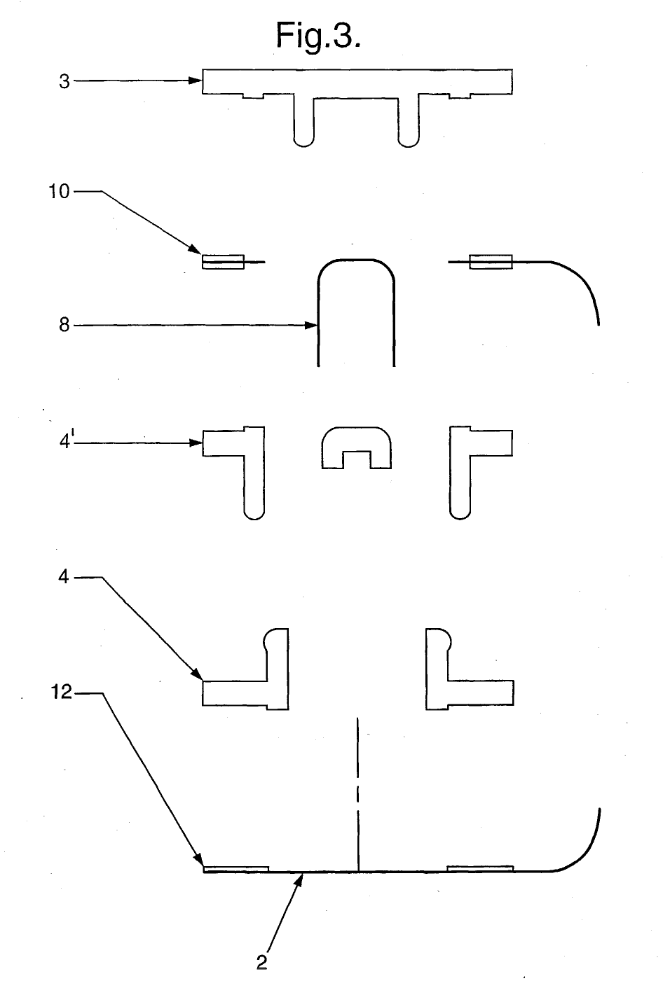

FIG. 3 is an exploded view of the container of FIG. 2;

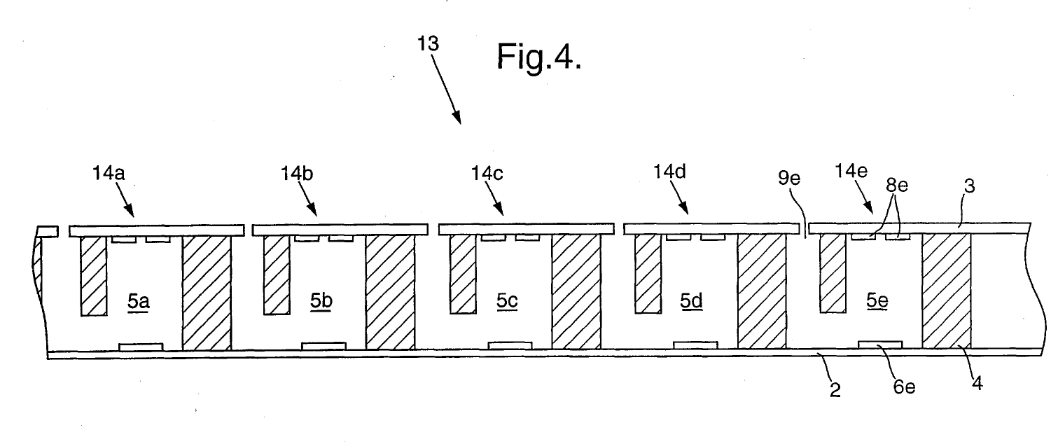

FIG. 4 is a schematic cross section of a multiplex container according to the invention;

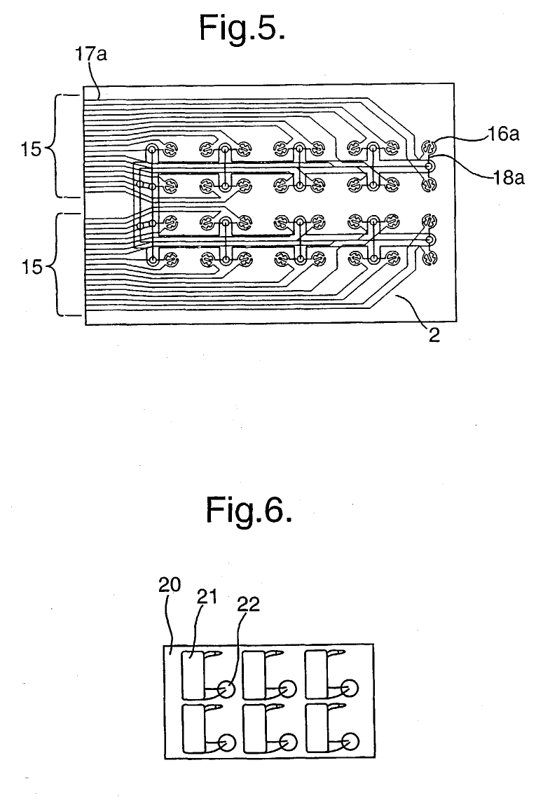

FIG. 5 is a plan view of heater means circuitry of a multiplex container according to the invention;

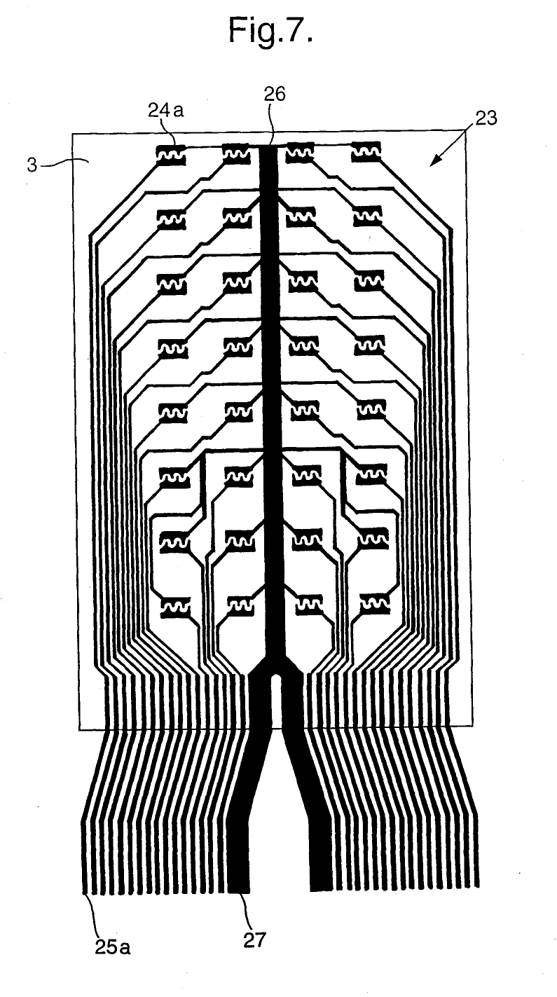

FIG. 6 is a plan view of a portion of a void defining layer of a multiplex container according to the invention;

FIG. 7 is an enlarged plan view of the conductivity detecting means circuitry of a multiplex container according to the invention;

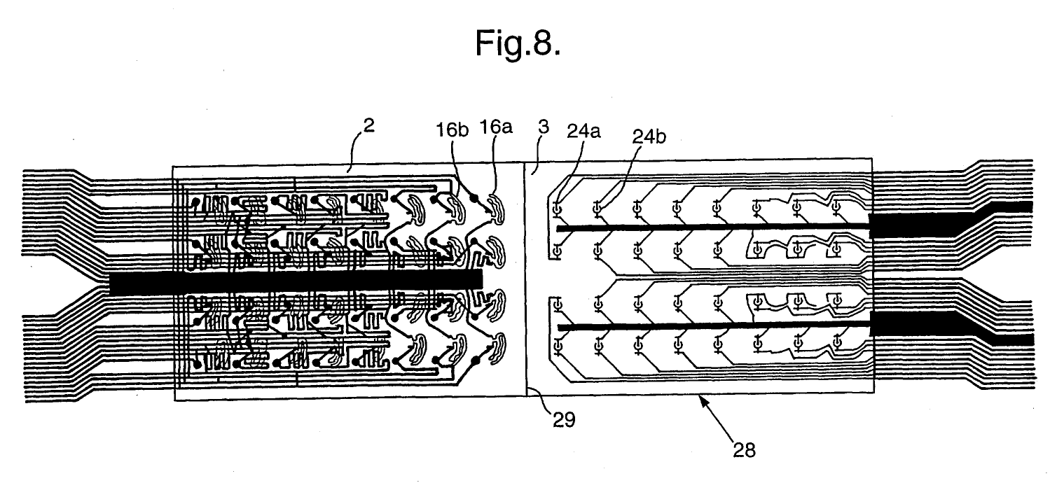

FIG. 8 is a plan view of the heater means circuitry and the conductivity detecting means circuitry of an embodiment of a multiplex container according to the invention in which the heater means circuitry and the conductivity detecting means circuitry are printed onto a single foldable sheet;

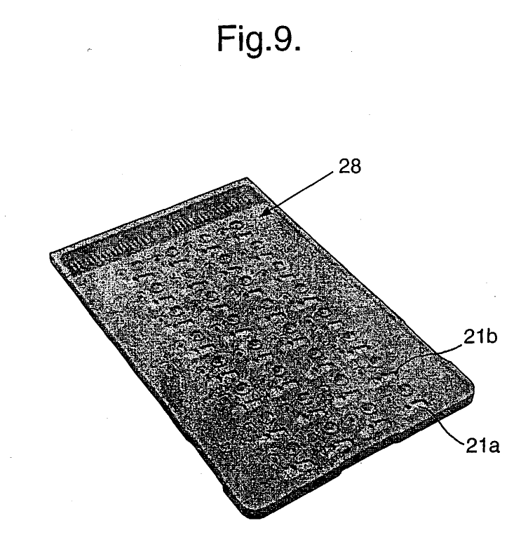

FIG. 9 is a perspective view of a multiplex container according to the invention;

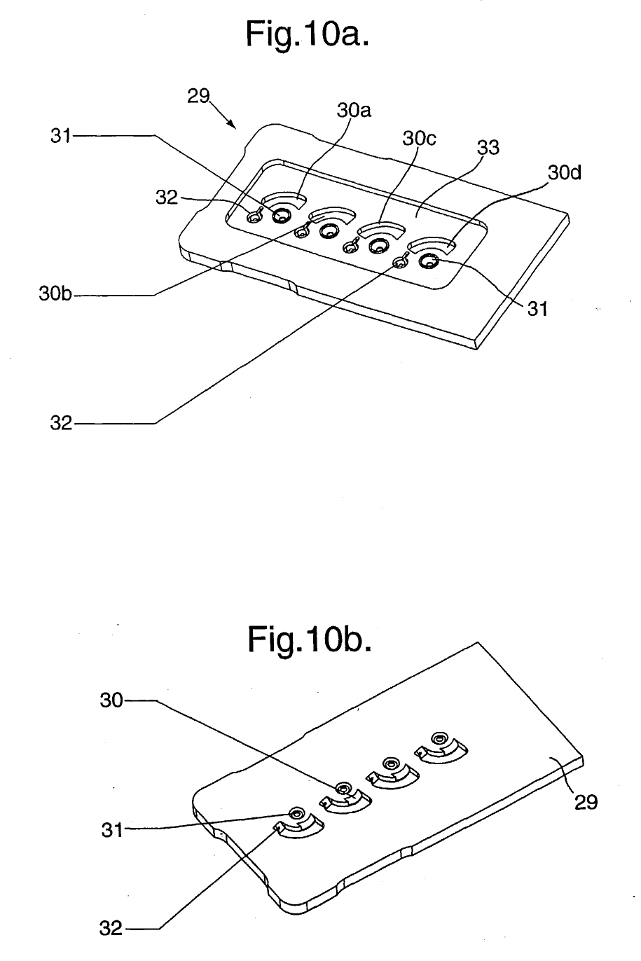

FIG. 10a is a perspective view from above of a part of a further embodiment of a container of the invention;

FIG. 10b is a perspective view from below of the container part of FIG. 10a;

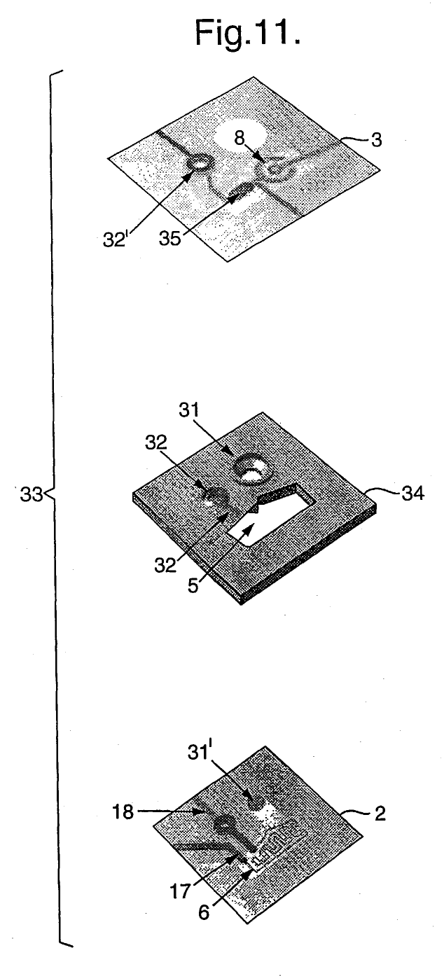

FIG. 11 is an exploded view of yet another embodiment of the invention in which a sample container is formed from three components;

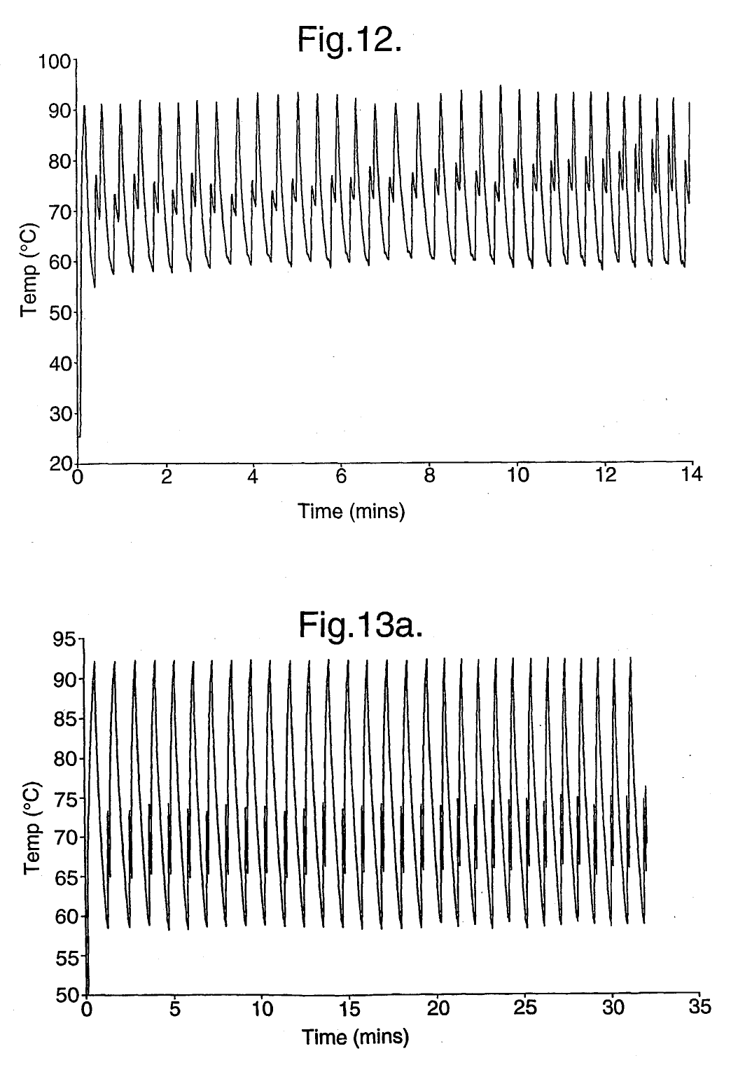

FIG. 12 is a graph of the variation of temperature of the sample with time on heating a sample as described in Example 1 below;

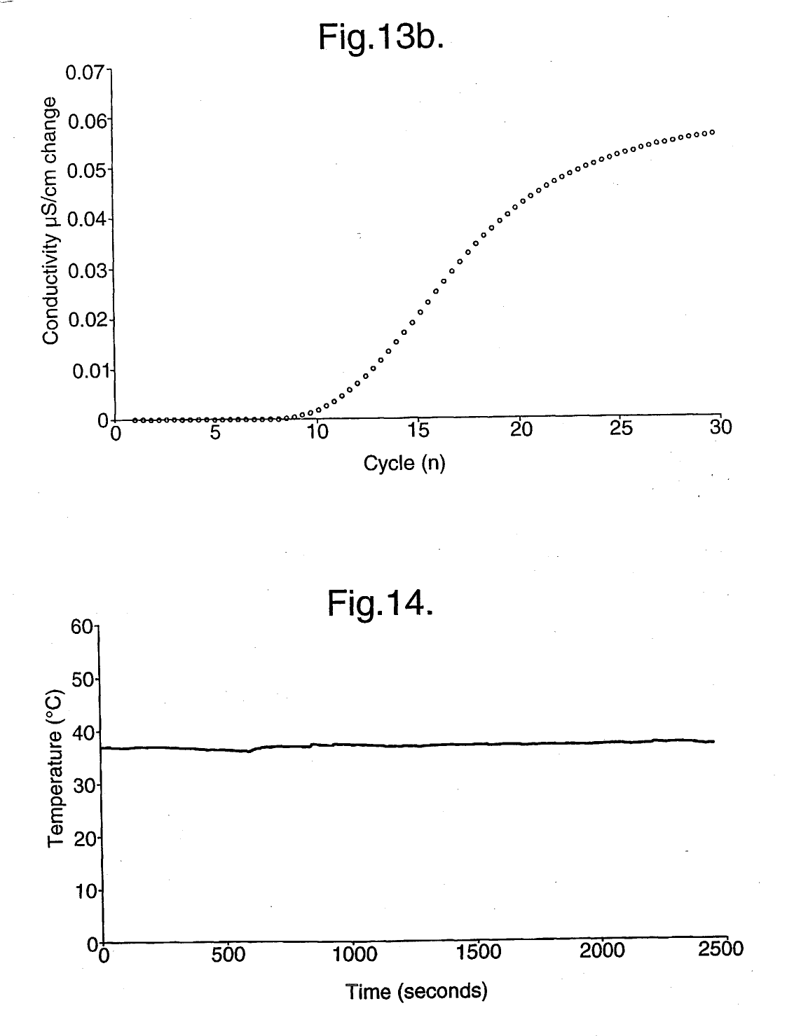

FIG. 13a is a graph showing the variation of temperature with time in a PCR reaction carried out using a container of the invention as described in Example 2 below;

FIG. 13b is a graph showing conductivity measurements in the PCR reaction to which FIG. 13a relates;

FIG. 14 is a graph showing the variation of temperature with time in a nuclease digestion protocol carried out using the container of the invention as described in Example 3 below; and

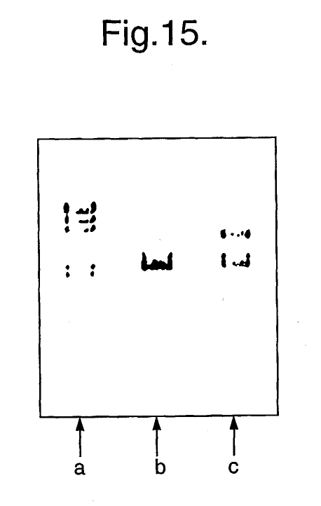

FIG. 15 is a representation of a gel on which had been separated the products of the nuclease digestion protocol of Example 3 below;

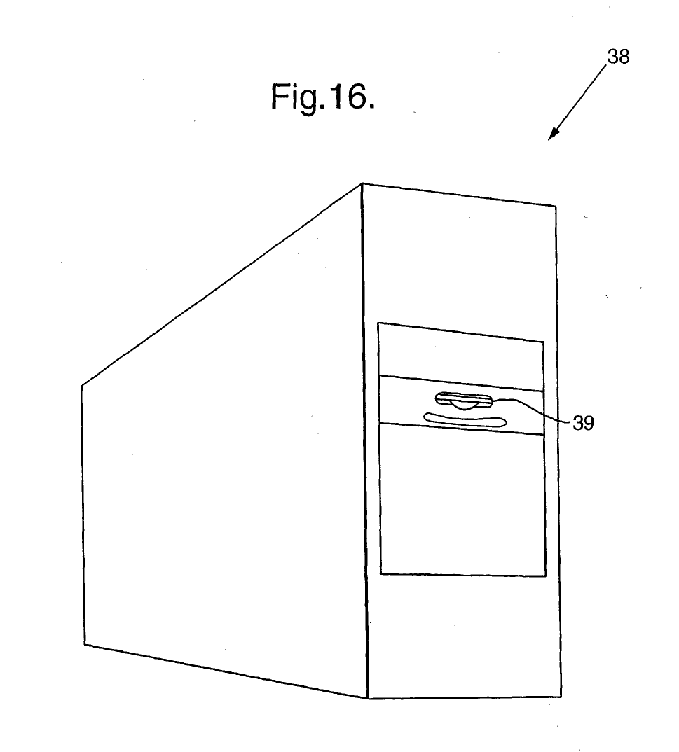

FIG. 16 is an illustration of an apparatus with which the container of the invention can be used;

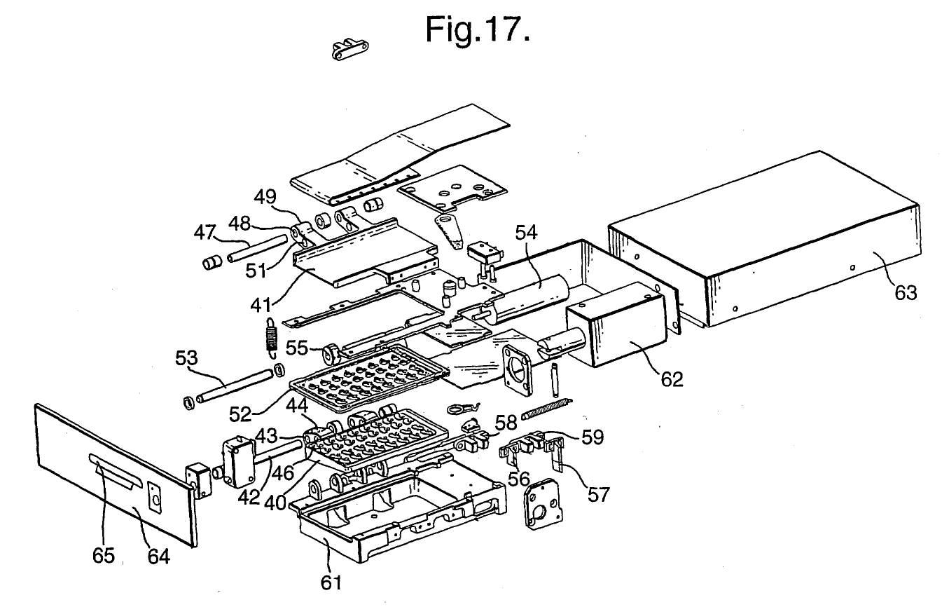

FIG. 17 is an exploded view of a sample holder apparatus in accordance with the second aspect of the invention including a sample container;

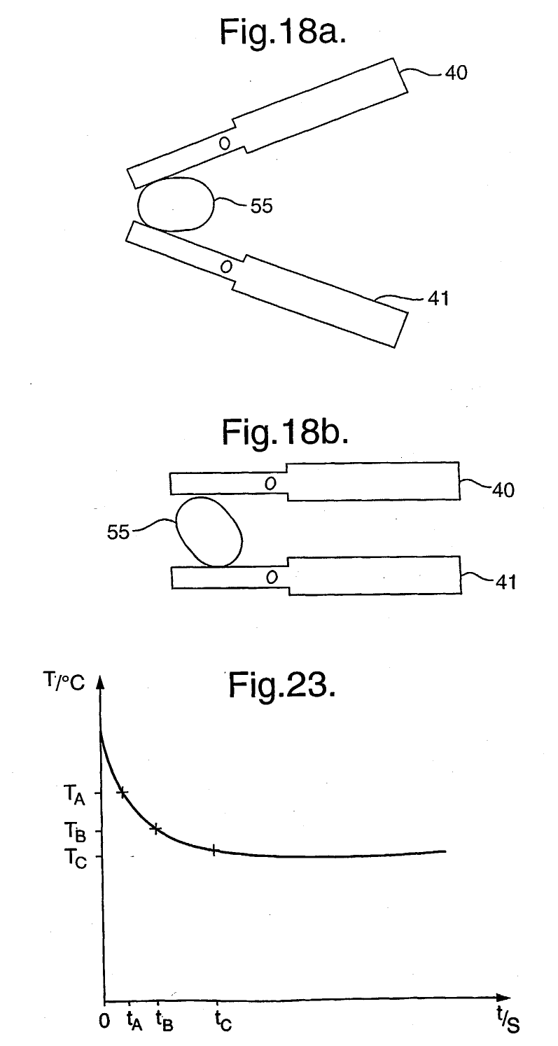

FIG. 18a is a schematic view of a sample holder in accordance with the invention showing the drive means portion;

FIG. 18b is a schematic view of the sample holder showing the drive means portion of FIG. 18a in the closed position;

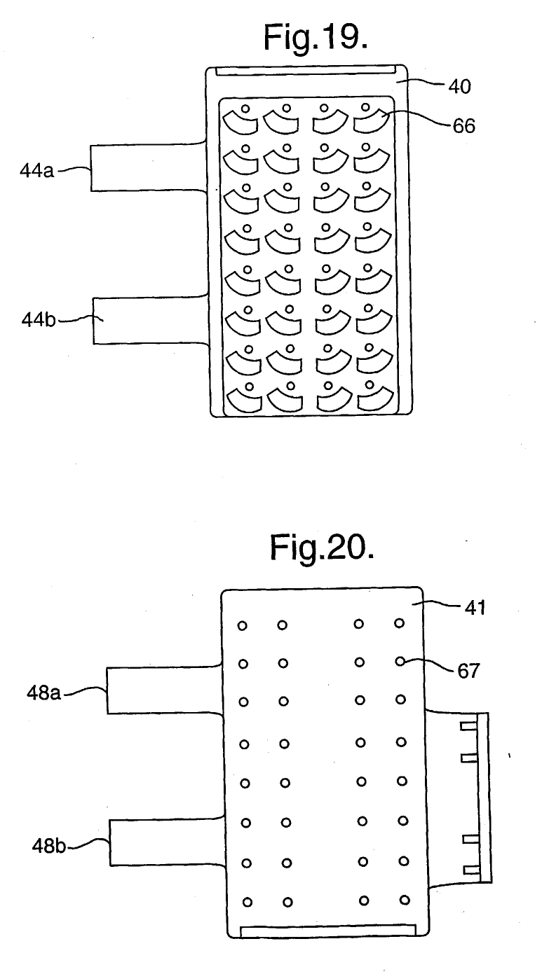

FIG. 19 is a plan view of a clamp plate including heat sink contact portions;

FIG. 20 is a plan view of a clamp plate with pressure directing nodules;

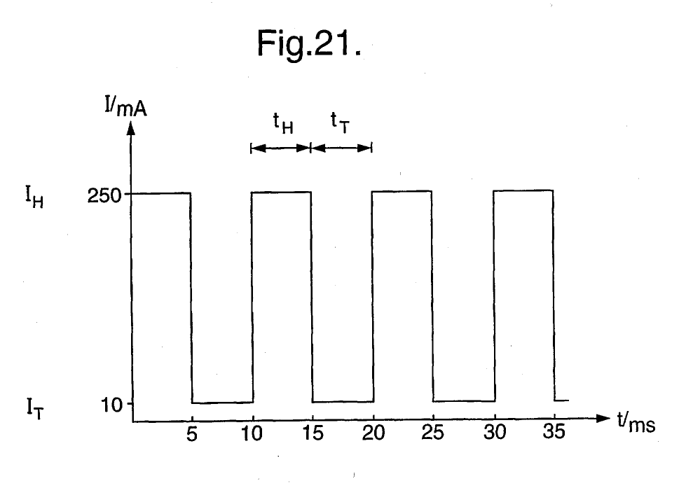

FIG. 21 is a graph showing the pulsed variation of current to an electrically resistant element in accordance with a method of the invention;

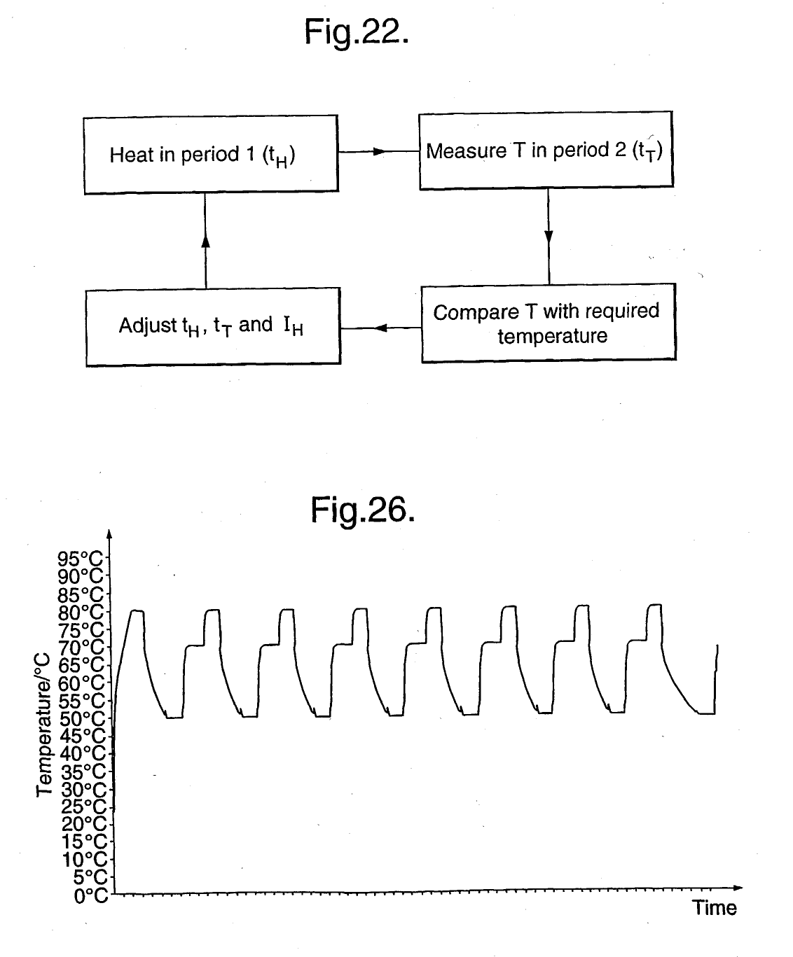

FIG. 22 is a flow chart showing the steps of the method of the invention;

FIG. 23 is a graph showing the cooling of an electrically resistive element during a second period in a method according to the invention;

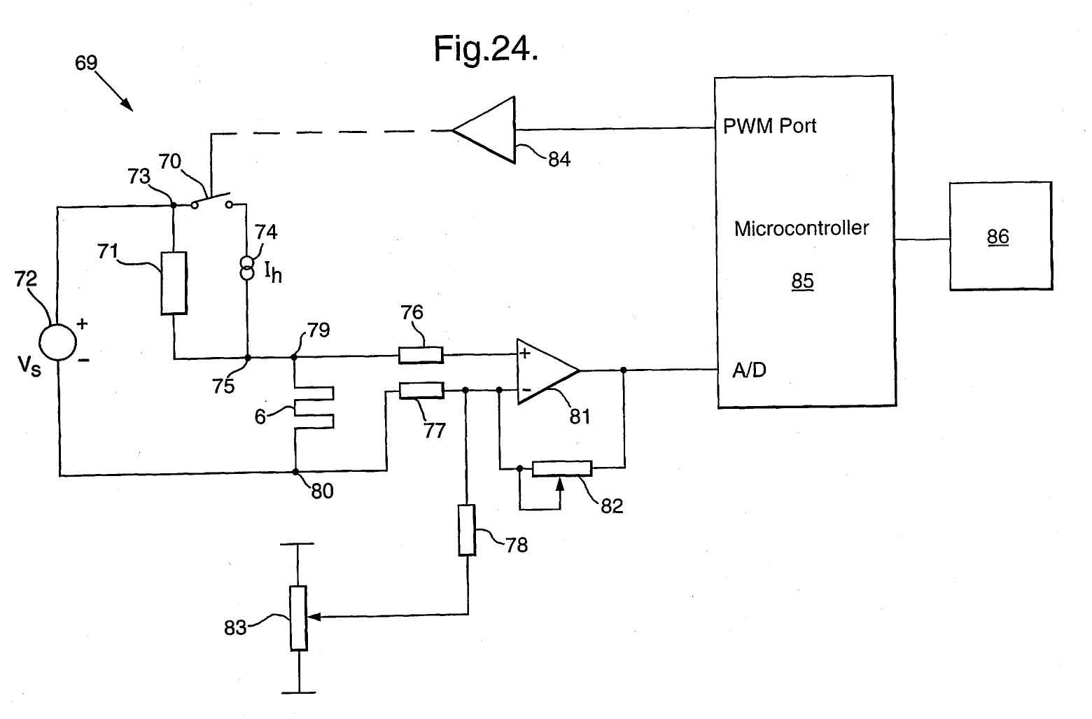

FIG. 24 shows a circuit diagram for a circuit suitable for implementing the method of the invention;

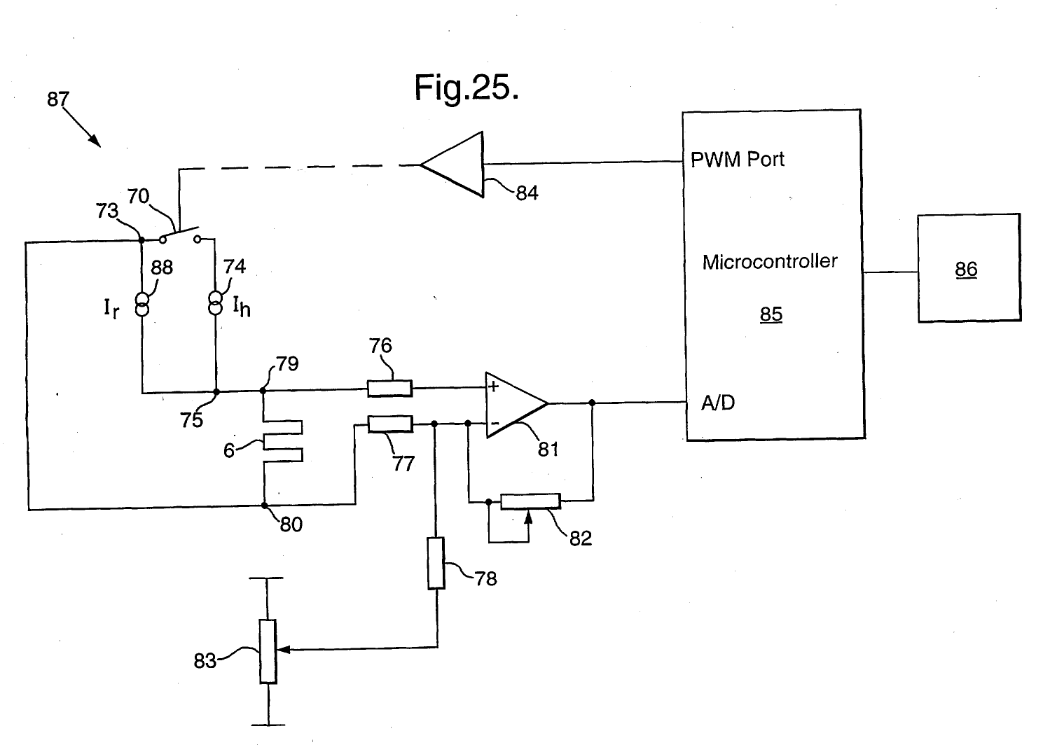

FIG. 25 shows a second circuit diagram for a circuit suitable for implementing the method of the invention; and

FIG. 26 shows the variation of sample temperature with time for a typical thermal cycling experiment.

Referring to FIG. 1 of the drawings, a container, indicated generally by the reference numeral 1, comprises a planar lower member 2, a planar upper member 3 and walls 4, 4′ which define a sample receiving space 5. The walls 4, 4′ are formed by a central planar member which extends between, and parallel to, the planar upper and lower members 2 and 3. The lower member 2 carries a screen printed electric resistive heater 6. The upper surfaces of the electric resistive heater 6 and lower member 2 are covered by a passivator layer 7 (not shown in this Figure) which is electrically insulating. The upper member 3 has attached to its inner surface a conductivity sensor 8. To one side of the sample receiving space 5 is an access tube 9.

Referring to a further embodiment shown in FIG. 2, an assembled container, indicated generally by the reference numeral 1, comprises a lower member 2 and an upper member 3 and wall portions 4 and 4′. The upper member 3 is mounted on wall portions 4′. The engagement between the lid 3 and the wall portion 4′ is made airtight by a tape seal 10 that extends around the rims of the wall portion 4′. The lid 3 has attached to its inner surface a conductivity sensor 8 held in place by holding member 11 and adhesive. Wall portion 4 is mounted on lower member 2, which carries a screen printed electric resistive heater 6 (not shown in FIG. 2). The engagement between the wall portion 4 and lower member 2 is made airtight by a tape seal 12 that extends around the lower edge of wall portion 4. The screen printed resistive heater 6 is coated by a passivator layer 7 (not shown in FIG. 2) which is electrically insulating. The wall portions 4 and 4′ and the lid 3 are approximately 0.5 to 2.0 mm, for example, 1 to 1.5 mm thick.

The container of FIG. 2 is shown in FIG. 3 in an exploded view.

Referring to FIG. 4, a multiplex array of wells, indicated generally by reference numeral 13 is shown. The portion of the multiplex array shown has five wells indicated generally as 14a to 14e. Each well in the array has the same basic features as the container in FIG. 1. Taking well 14e, lower member 2, upper member 3 and walls 4 define a sample receiving space 5e. The lower member 2 carries a screen printed electric resistive heater 6e. The electric resistive heater 6e is coated by a passivator layer 7e (not shown) which is electrically insulating. The upper member 3 has attached to its inner surface a conductivity sensor 8e. To one side of the sample receiving space 5e is an access tube 9e.

In FIG. 5, the circuit layout indicated generally as 15 on the lower surface 2 of the well array is seen. Each of wells 14a to 14ff has a screen printed electric resistive heater 16 connected to an individual power supply via a respective electrical connection 17 and an electrical output to earth via an electrical connection 18. The electrical output connection 18 passes through a hole in the base 2 to an output conductor 19 on the other side of the base (not shown in FIG. 5).

The void-defining layer 20 as seen in FIG. 6 comprises a plurality of apertures (six apertures are shown in the Figure) 21a to 21f appropriately spaced to fit over the heater elements 16a to 16ff. The apertures 21a to 21f constitute an array of receptacles which, together with lower member 2, define a corresponding array of sample spaces. Each aperture 21 has an access tubelet 22 through which fluid is delivered into the sample space defined by aperture 21, lower member 2 and upper member 3 by capillary action. Void-defining layer 20 has a thickness of approximately 1 mm, and each aperture has a width of approximately 3 mm and a length of approximately 6 mm thus defining a sample volume of approximately 20 μl.

The upper member 3 may comprise a polyester sheet which carries conductivity detecting means circuitry 23 including a plurality of conductivity probes 24 (see FIG. 7). FIG. 7 is drawn on a different scale from FIG. 6. In practice, the upper member 3 and cover member 2 will be of similar dimensions so that each conductivity probe 24 will be in register with a corresponding heater 16 of FIG. 6. Each of wells 14a to 14ff has a screen printed conductivity probe 24a to 24ff connected to a detection means via an electrical connection 25 and an electrical conductivity meter supply provided by an electrical connection 27.

Referring to FIG. 8 of the drawings, the heater elements 16a to 16ff and the conductivity probes 24a to 24ff are printed onto a single sheet 28 which may be folded along central fold line 29.

FIG. 9 shows a part-assembled array of wells formed from a single sheet 28 carrying the heater elements 16a to 16ff and the conductivity probes 24a to 24ff folded around a void-defining layer 18 which defines holes 21a to 21ff.

Referring to FIGS. 10a and 10b, a portion of a void defining layer of an embodiment including an array of wells is shown. In the embodiment, void defining layer 29 defines sample spaces 30a to 30d (four wells are shown in the Figure but more may be present). Each well has associated with it an access tube 31 and a vent 32. Each well 30 is curved. The peripheral portions of the void defining layer 29 are raised such that the central portion 33 is recessed below the height of the peripheral portion. When member 2 provided with a screen-printed heater element (not shown in FIG. 10) is positioned on the void defining layer, there is a gap between the central portion 33 of the void defining layer and member 2. This gap creates a fluid contact between access tube 31, vent 32 and well 30 and thus a sample inserted through access tube 31 may enter the well 30. Once the sample has been deposited in the well, pressure is applied by a clamp 36 (not shown) to the void defining layer 29 and member 2 such that they are pressed together and the gap between the inset central portion 33 of void defining layer 29 and member 2 is closed.

In FIG. 11, a single well indicated generally by reference numeral 33, is shown. The well may be a part of an array of wells. The well 33 comprises a lower member 2, an upper member 3 and a void defining layer 34 which defines a sample receiving space 5. The lower member 2 carries a screen printed electric resistive heater 6. The electric resistive heater 6 is coated by a passivator layer 7 which is electrically insulating (not shown in this Figure). Electric resistive heater 6 is provided with electrical connection 17 and output connection 18. The upper member 3 has attached to its lower surface a conductivity sensor 8. To one side of the sample receiving space 5 is an access tube 9. The receptacle further comprises vent 32, and temperature sensor 35. Reference numeral 31¹ designates a gasket seal for access tube 31 and reference numeral 32¹ designates a gasket seal for vent 32.

The containers described in any of FIGS. 1 to 11 may optionally fit into a receiving apparatus 36 (not shown in FIGS. 1 to 11, shown as opening 39 in computer 38 in FIG. 16 and as opening 65 in the apparatus of FIG. 17) which supplies power to the heaters and takes readings from the conductivity and temperature detection means. Receiving apparatus 36 contains terminals which make electrical contact with the heater circuits and the conductance measurement circuits. Control means connected to the terminals may control the power supply to each receptacle heater means individually. Further, the container of the invention or each of an array of containers may be equipped with a heat sink cooling element 37 (not shown in FIGS. 1-11, shown as heat sink portion 66 in FIG. 17) which may be brought into contact with the top, bottom or side surfaces of a well and which efficiently conducts heat away from the fluid.

FIG. 16 shows an apparatus for use with the container of the invention, comprising a computer 38 having drive means 39 into which the container, if necessary in a suitable carrier, can be inserted.

FIG. 17 shows an exploded view of a sample holder apparatus in accordance with the invention. The apparatus comprises a first plate 40 and a second plate 41. Communicating member 42 is rotatably mounted on first plate 40 through a distal hole 43 in projecting member 44. Plate 40 is rotatably mounted on a first rod 45 (not shown) through proximal hole 46 in projecting member 44. Similarly, communicating member 47 is rotatably mounted on second plate 41 through a distal hole 48 in projecting member 49. Second plate 41 is rotatably mounted on a second rod 50 (not shown) through proximal hole 51 in projecting member 49. In use a sample container 52 is located between the two plates. Drive shaft 53 is attached to motor 54 and a drive member 55 is fixed to shaft 53. Drive member 55 is ovoid in cross section.

Optic flags 56 and 57 are attached to second plate 41. Optic switches 58 and 59 are mounted on first plate 40 in a location such that optic flag 56 engages with optic switch 58 and optic flag 57 engages with optic switch 59 to provide information to the plate controller 60 (not shown).

First and second plates 40 and 41 are rotatably mounted through first rod 45 (not shown) and second rod 50 (not shown) on chassis 61. The sample holder is provided with a solenoid 62 which serves to push sample container 52 out of the holder when expulsion of sample container 52 is required. Solenoid 62 is under the control of the plate controller 60 (not shown).

The sample holder is encased in an external box 63 with a facia 64. Facia 64 includes an opening 65 for the insertion and removal of sample container 52.

FIG. 18a is a schematic view of a sample holder in accordance with the invention in the open position. As mentioned previously, drive member 55 is of ovoid cross-section. After insertion of a sample container, drive member 55 is rotated by means of a motor (not shown in FIG. 18a) so as to cause plates 40 and 41 to close against the outer surfaces of the sample container, thereby sealing the entrances of any access tubes in those surfaces. FIG. 18b shows the holder in the closed position.

FIG. 19 shows a plan view of first plate 40. Plate 40 is provided with projecting heat sink contact portions 66 shaped to correspond with wells 30 in sample container 52 (as shown in FIGS. 10a and 10b). First and second projecting members 44a and 44b project from plate 40 and provide proximal hole 46 (not shown) and distal hole 43 (not shown) for attachment to first rod 45 (not shown) and communicating member 42 (not shown) respectively.

FIG. 20 shows a plan view of second clamp plate 41. Plate 41 is provided with projecting nodules 67 each arranged to correspond with wells 30 in sample container 52 (as shown in FIGS. 10a and 10b). First and second projecting members 49a and 49b project from plate 41 and provide proximal hole 51 (see FIG. 17) and distal hole 48 (see FIG. 17) for attachment to second rod 50 and communicating member 47 respectively. Each nodule 67 is so positioned that it can apply pressure to the outer surfaces of sample container 52 adjacent to the or each sample well 30 (not shown), thereby assisting in closing an access opening 68 (not shown). In FIG. 21, a graph showing heater current against time for a typical experiment is shown. The experiment may be performed using a container of the type shown in any one of

FIGS. 1, 2, 3, 4, 9, 10a, 10b or 11. In a first period t_{H} (the heating period), between 0 and 5 ms, the current I_{H} supplied to the electrically resistive element 6 is approximately 250 mA. During the second period t_{T}, between 5 and 10 ms, the current I_{T} supplied to the electrically resistive element 6 is approximately 10 mA, which is sufficient to enable the resistance of the electrically resistive element 6 to be measured but not sufficient to cause appreciable heating.

FIG. 22 is a feedback loop showing how the information gained about the temperature in the second period t_{T} (the temperature measuring period) may be used by control means 5 to set the values of I_{H}, t_{H} and t_{T}.

In FIG. 23, the cooling of an electrically resistive element 6 during the second period t_{T} (the temperature measuring period) is shown. At times t_{A}, t_{B} and t_{C} the element 6 has cooled to temperatures T_{A}, T_{B} and T_{C} respectively. From the rate of cooling, it is possible to deduce the temperature T_{∞}, towards which the electrically resistive element is cooling.

FIG. 24 shows a circuit diagram, indicated generally by reference numeral 69 which is suitable for use in a control means or a holder of the invention. Circuit 69 comprises a switch 70 with a first terminal, a second terminal and a control terminal the potential at the control terminal determining whether the switch is open or closed, a resistor 71 with a first terminal and a second terminal and a voltage source 72 with a positive terminal and a negative terminal, the first terminal of switch 70 and the first terminal of resistor 71 being connected to the positive terminal of voltage source 72 at junction 73. The circuit further comprises a current source 74 with a first terminal and a second terminal. The second terminal of switch 70 is connected to first terminal of current source 74 and the second terminal of current source 74 is connected to the second terminal of resistor 71 at junction 75. The circuit further comprises electrically resistive element 6 with a first terminal and a second terminal, resistor 76 with a first terminal and a second terminal, resistor 77 with a first terminal and a second terminal and resistor 78 with a first terminal and a second terminal. The first terminal of electrically resistive element 6 and first terminal of resistor 76 are connected at junction 79, which in turn is connected to junction 75. The second terminal of electrically resistive element 6 is connected to the negative terminal of voltage source 72 at junction 80 which junction is connected to first terminal of resistor 77.

The circuit further comprises an amplifier 81 with a positive input, a negative input and an output. The positive input of amplifier 81 is connected to the second terminal of resistor 76 and the negative input is connected to the second terminal of resistor 77. The output of amplifier 81 is connected to an analogue to digital converter input of microcontroller 85. The circuit further comprises variable resistor 82 with a first terminal, a second terminal and a third terminal, and variable resistor 83 with a first terminal, a second terminal and a third terminal. The first terminal of variable resistor 82 is connected to the output of amplifier 81 and is at a first potential. The second terminal of variable resistor 82 is connected to the negative input of amplifier 81 and is at a second potential. The third terminal of variable resistor 82 is an input having a voltage between the first and the second potential depending on the setting of the variable resistor. The first terminal of variable resistor 83 is held at a first potential and second terminal of variable resistor 83 is held at a second potential. The third terminal of variable resistor 83 is an output having a voltage between the first potential and the second potential depending on the setting of the variable resistor. The first terminal of resistor 78 is connected to the third terminal of variable resistor 83 and the second terminal of resistor 78 is connected to the negative input of amplifier 81.

The circuit further comprises amplifier 84 with an input connected to an output of microcontroller 85 and an output connected to the control terminal of switch 70. Microcontroller 85 may be connected to a Personal Computer 86, for example via an RS232 port.

In use when switch 70 is open, voltage from power supply 72 causes a current to flow through resistor 71 and electrically resistive element 6. There is a drop in potential across electrically resistive element 6 and that drop gives rise to a potential difference between the positive and negative terminals of amplifier 81. Accordingly the output of amplifier 81 is a measure of the drop in potential across electrically resistive element 6. Variable resistor 83 enables a compensating potential to be added to the negative input potential so that the amplifier is not saturated in the desired range of magnitudes of potential differences across electrically resistive element 6. Variable resistor 82 may be used to vary the gain of amplifier 81 so that the amplifier is not saturated in the desired range of potential differences across electrically resistive element 6. The output current of amplifier 81 is connected to microcontroller 85 and is interpreted by the microcontroller as a measurement of the temperature of the electrically resistive element 6, for example by comparison with a previously established calibration curve of resistance of the electrically resistive element at a plurality of temperatures.

When switch 70 is closed, current source 74 provides a current to electrically resistive element 6 (effectively short-circuiting resistor 71). The current source is so arranged that the current is sufficiently large that electrically resistive element 6 becomes warm due to resistive heating. The drop in potential across electrically resistive element 6 is generally so large that amplifier 81 becomes saturated and no useful information regarding the temperature of electrically resistive element 6 can be deduced.

The switching of switch 70 between the open and closed positions is controlled by microcontroller 85. The PWM (Pulse Width Modulation) signal dictated by microcontroller 85 determines the relative lengths of the heating and temperature measuring periods and hence the rate of heating a sample.

To protect amplifier 81, it should ideally only be connected to electrically resistive element 6 when switch 70 is open (i.e. when I_{T} and not I_{H} is flowing through electrically resistive element 6).

FIG. 25 shows an alternative circuit diagram, indicated generally by reference numeral 87. Circuit 87 is the same as circuit 69 described above with the exception that, in circuit 87, voltage source 72 and resistor 71 are not present and instead the circuit comprises second current source 88, having a first terminal and a second terminal. First terminal of current source 88 is connected to the second terminal of switch 70 at junction 73 and the second terminal of current source 88 is connected to the second terminal of current source 74 at junction 75.

In use when switch 70 is open, current I_{T} is supplied from current source 88 through electrically resistive element 6. There is a drop in potential across electrically resistive element 6 and that drop gives rise to a potential difference between the positive and negative terminals of amplifier 81. Accordingly the output of amplifier 81 is a measure of the drop in potential across electrically resistive element 6. Variable resistor 83 enables a compensating potential to be added to the negative input potential so that the amplifier is not saturated in the desired range of magnitudes of potential differences across electrically resistive element 6. Variable resistor 83 may be used to vary the gain of amplifier 81 so that the amplifier is not saturated in the desired range of potential differences across electrically resistive element 6. The output current of amplifier 81 is connected to microcontroller 85 and is interpreted by the microcontroller as a measurement of the temperature of the electrically resistive element 6.

When switch 70 is closed, current sources 88 and 74 both provide a current to electrically resistive element 6. Current source 88 provides current I_{T} and current source 74 provides current I_{H}. Current source 74 is so arranged that current I_{H} is sufficiently large that electrically resistive element 6 becomes warm due to resistive heating. The drop in potential across electrically resistive element 6 is generally so large that amplifier 81 becomes saturated and no useful information regarding the temperature of electrically resistive element 6 can be deduced. To protect amplifier 81, it should ideally only be connected to electrically resistive element 6 when switch 70 is open (i.e. when I_{T} and not I_{H} is flowing through electrically resistive element 6).

In FIG. 26, there is shown a trace of sample temperature against time for a typical PCR thermal cycling experiment. Initially, the sample is heated from ambient temperature to the denaturation temperature (here 80° C.). After a time at the denaturation temperature, the sample is allowed to cool to the annealing temperature (here 50° C.). After sufficient time at the annealing temperature, the sample is heated to the extension temperature (here 70° C.). After sufficient time at the extension temperature, the sample is again heated to the denaturation temperature after which the cycle is repeated. Seven cycles are shown.

The desired temperature profile may be entered into and stored on a computer (for example microcontroller 85 or PC 86) and the sample subjected alternately to heating and temperature measurement as described above. The resistance of the resistive element 6 during the temperature measurement phase is evaluated by the microcontroller 85 having regard to the stored temperature profile, and the microcontroller then calculates an appropriate value of I_{H} and optionally also of t_{H} and t_{T} for maintaining the desired temperature profile.

The following examples illustrate the invention further:

### EXAMPLE 1

### Heating Method Example

In an apparatus described above with reference to FIGS. 1, 2, 3, 4, 9, 10a, 10b, 11 and 16, a sample of 20 μl of water was heated to a constant temperature of 60° C. using a pulsed heat supply, with an “off” time T_{L} of 0.4 seconds, and an “on” time T_{H} of 0.6 seconds, with an amplitude A of 5 V. The variation of temperature of the sample with time are shown in FIG. 12.

### EXAMPLE 2

### Use of a Container of the Invention in a PCR Protocol

In a polymerase chain reaction (PCR) it is necessary to repeatedly heat and cool a sample. By alternating heating the receptacle contents with thermally contacting the receptacle contents with the heat sink 26, temperature cycling may be achieved. An example of the temperature profile achieved is shown in FIG. 13a, which relates to a PCR reaction using 10 ng target DNA with 10 pmoles primers in the presence of 1 unit of Taq polymerase and 1 mM of magnesium chloride. The amplification target was a cloned actin insert. In the reaction, the sample is held at 92° C. for 1 second, 59° C. for 5 seconds and at 72° C. for 12 seconds, 30 cycles were carried out. Temperature control during the extension phases of the reaction was achieved by using an “off” value (T_{L}) maintained for 0.2 sec alternately with an “on” value (T_{H}) of 0.6 sec with an amplitude (A) of 5 V to achieve a target temperature of 72° C. FIG. 13b shows the increase in the concentration of the cloned DNA, as demonstrated by measurement of the conductivity of the sample.

### EXAMPLE 3

### Use of the Container of the Invention in a Nuclease Digestion Protocol

A solution containing 1.0 ng pUC18 DNA, 5 μg BSA (Bovine Serum Albumin), 1× buffer and 10 units Pvu II was made up to a final volume of 50 μl. The mixture was placed in a container according to FIG. 1. The container used has a capacity of 20 μl so only that quantity entered the receptacle. The reaction mixture was heated to approximately 37° C. by the heater and the temperature of the sample was recorded. The apparatus was set to maintain the temperature at approximately 37° C. for 45 minutes and the trace of actual temperature against time is shown in FIG. 14. After 45 minutes, the temperature was increased to 65° C. and held at that level for 15 minutes (not shown in FIG. 14). The reaction product was then subjected to gel electrophoresis on 1% agarose gel in 0.5× TBE (TRIS-borate-EDTA) at 120V. Bands were visualised in the gel by addition of ethidium bromide. The gel trace is shown in FIG. 15. Lane a contained λDNA/HindIII markers, lane b contained undigested plasmid DNA, and lane c contained digested plasmid after nuclease digestion.

1. A sample container for a fluid sample comprising a support, a receptacle which, together with the support, defines a sample space, and heater means affixed to said support in thermal contact with, but electrically insulated from, the sample space.

2. A sample container as claimed in claim 1 wherein the sample space has a capacity of not more than 1 ml.

3. A sample container comprising a support, an array of discrete receptacles which, together with the support, defines an array of sample spaces each arranged to receive a sample of fluid, and heater means affixed to said support in thermal contact with, but electrically insulated from, the sample spaces, wherein the heater means is so arranged that it can apply to one or more sample spaces of the array heating conditions that are different from those applied to another sample space or sample spaces of the array.

4. A sample container as claimed in claim 3 in which the heater means comprises a multiplicity of heater elements.

5. A sample container as claimed in claim 4 in which each heater element is arranged to heat a respective individual sample space.

6. A sample container as claimed in any one of claims 3 to 5 wherein each sample space has a capacity of not more than 100 μl.

7. A sample container as claimed in any one of claims 1 to 6 wherein the or each heater means is applied onto the support.

8. A sample container as claimed in any one of claims 1 to 7 wherein the or each heater means is directly or indirectly printed onto the support.

9. A sample container as claimed in any one of claims 1 to 8 in which the support is of laminar configuration.

10. A sample container as claimed in any one of claims 1 to 9 wherein the or each sample space is formed from at least three cooperating members, comprising a first member having a substantially flat surface comprising a heating element, a second member being a layer having an aperture defining a void or a plurality of apertures defining a plurality of voids and a third member having a substantially flat surface.

11. A sample container as claimed in any one of claims 1 to 10 wherein the sample container is detachable from a power- and control-supplying means.

12. A sample container as claimed in any one of claims 1 to 11 wherein the or each sample space has an arcuate shape viewed perpendicularly to the plane of the support defined by an acuate wall, the arcuate sample space having a width such that the meniscus of the sample fluid can simultaneously contact the wall on both sides of the sample space when entering the sample space.

13. A sample container as claimed in any one of claims 1 to 12 wherein the sample container comprises an array of sample spaces, each arranged to receive a sample of fluid, wherein the heater means is so arranged that it can apply to one or more sample spaces of the array heating conditions that are different from those applied to one or more other sample spaces of the array.

14. A sample container for a fluid sample comprising a receptacle defining a sample space, a support upon which the receptacle is received and screen printed heater means affixed to said support in thermal contact with, but electrically insulated from the sample space.

15. A sample container for a fluid sample comprising a support, means defining a sample space on the support and heater means affixed to the support in thermal contact with the sample space wherein the means defining the sample space, the support and the heater means form an integrated unit.

16. A sample container for a fluid sample comprising a substantially planar body defining at least one sample space in said body and heater means integrated within said body, the heater means being in thermal contact with the sample space.

17. A sample container as claimed in any of claims 14 to 16 comprising one or more additional features as defined in any of claims 1 to 13.

18. An apparatus comprising a sample container as claimed in any one of claims 1 to 17 and control means which controls the heater means of the sample container.

19. An apparatus comprising a sample container as claimed in any one of claims 1 to 17 having a multiplicity of sample spaces, each associated with a respective heater element, the control means being arranged to control each heater element individually in dependence upon a value related to temperature generated from temperature sensing means associated with the corresponding sample space.

20. Use of a sample container as described in any one of claims 1 to 17 for heating a fluid chemical sample.

21. Use as claimed in claim 20 substantially as described herein with reference to the Examples.

22. A sample container for a fluid sample comprising a first portion and a second portion, a receptacle defining a sample space located between the first portion and the second portion, an access tube for depositing a sample in the sample space, and a communication channel through which the access tube communicates with the sample space, wherein the container is deformable such that the application of pressure pressing the first portion and the second portion together causes the communication channel to be closed.

23. A sample container as claimed in claim 22 wherein the sample space has a capacity of not more than 1 ml.

24. A sample container comprising a first portion and a second portion, an array of discrete receptacles, each receptacle defining a sample space located between the first portion and the second portion and being arranged to receive a sample of fluid, an access tube associated with each sample space for depositing a sample in the sample space and a communication channel associated with each sample space through which each access tube communicates with its associated sample space, wherein the container is deformable such that the application of pressure pressing the first portion and the second portion together causes the communication channels to be closed.

25. A sample container as claimed in claim 24 wherein each sample space has a capacity of not more than 100 μl.

26. A sample container as claimed in any one of claims 22 to 25 wherein the container is resiliently deformable.

27. A sample container as claimed in any one of claims 22 to 25 wherein the or each receptacle further comprises a vent hole.

28. A sample container as claimed in claim 27 wherein the or each vent hole is sealable.

29. A sample container as claimed in any one of claims 22 to 28 which comprises a respective heating element associated with the or each sample space.

30. A sample container as claimed in any one of claims 22 to 29 wherein the or each sample space is formed from at least three cooperating members, comprising a first member having a substantially flat surface, a second member having an aperture defining a void or a plurality of voids each with an associated access tube and a communication channel through which the access tube communicates with the void, and a third member having a substantially flat surface, wherein the second layer is made of a resiliently deformable material such that the application of pressure pressing the first and third members together causes the or each communication channel to be closed.

31. A sample container as claimed in claim 30 wherein the communication channel is located between the first member and the second member or between the second member and the third member.

32. A sample container substantially as described herein with reference to the description and any of FIGS. 1 to 15.

33. A holder for a sample container, the sample container having at least first and second outer surfaces at least one of which has at least one access opening for the introduction of material into the container, the holder comprising a first plate and a second plate, said first and second plates being movable relative to one another between a first, open position and a second, closed position, the plates being so dimensioned and configured that, in the closed position, they can press against, respectively, said first and second outer surfaces of a said container and can cause the at least one access opening to be closed.

34. A holder as claimed in claim 33 wherein one of the plates is made of a thermally conducting material and is arranged to have an area of contact with a portion of the container adjacent a sample space so as to serve as a heat sink from the sample space.

35. A holder as claimed in claim 33 or 34 wherein one of the plates comprises a nodule or nodules arranged to correspond with an or each sample receptacle of said container, the or each nodule being so positioned that it can apply pressure to the first or second outer surfaces of the container adjacent to the or each sample receptacle, thereby assisting in closing the access opening.

36. A holder substantially as described herein with reference to FIGS. 17 to 20.

37. A method of heating a fluid sample wherein a voltage is applied across, or a current is supplied to, an electrically resistive element in such a fashion that the electrically resistive element serves as a heater in a first period and serves as temperature sensing means in a second period.

38. A method of heating a plurality of fluid samples wherein a voltage is applied across, or a current is supplied to, each of a plurality of electrically resistive elements in such a fashion that each electrically resistive element serves as a heater of a sample in a first period and serves as temperature sensing means of a sample in a second period.

39. A method as claimed in claim 38 wherein each of the plurality of fluid samples is heated independently.

40. A method as claimed in any one of claims 37 to 39 wherein the first period has a duration of from 0.1 msec to 100 sec.

41. A method as claimed in any one of claims 37 to 40 wherein the second period has a duration of from 1 msec to 100 msec.

42. A method as claimed in any one of claims 37 to 41 wherein information from the temperature sensing means in the second period is used by the control means to adjust the voltage applied across, or the current supplied to, the or each electrically resistive element during the first period.

43. A method as claimed in any one of claims 37 to 42 wherein the temperature determination comprises measurement of the resistance of the or each electrically resistive element during the second period.

44. A method as claimed in any one of claims 37 to 39 wherein the relationship of the resistance of the or each electrically resistive element circuit to the temperature of a sample is derived by calibration measurements of resistance of the electrically resistive element at a plurality of temperatures.

45. A method as claimed in any one of claims 37 to 44 wherein the or each temperature determination is carried out after a delay following the end of the first period.

46. A method as claimed in claim 45 wherein the delay is 250 msec.

47. A method as claimed in any one of claims 37 to 44 wherein the temperature of the or each sample is determined by estimation from the rate at which the electrically resistive element cools after the end of the first period.

48. A computer program product so arranged as to cause a computer to implement a method as claimed in any one of claims 37 to 47.

49. A method as claimed in any one of claims 37 to 47, in which there is used a sample container according to any one of claims 1 to 17.

50. A computer program product which causes a computer so to operate:
that it takes as an input a data set signal representing a desired profile of temperature for a fluid sample with time and an input data set signal representing the temperature of the fluid sample, and
that it converts the data set signals into an output signal that represents a duration and magnitude of voltage to be applied across, or a current to be supplied to, an electrically resistive element to heat the fluid sample,
wherein a control means is instructed to apply a voltage across, or supply a current to, the electrically resistive element in a first period and the input data set signal representing the temperature of the fluid sample is provided by the same electrically resistive element during a second period.

51. An apparatus for heating a fluid sample comprising a receiving space for receiving a sample, an electrically resistive element and control means wherein the control means is operable so as to apply a voltage across, or supply current to, the electrically resistive element in such a fashion that the electrically resistive element may serve as a heater in a first period and may serve as temperature sensing means in a second period.

52. An apparatus as claimed in claim 51 wherein the receiving space for receiving a sample comprises a space for a sample container.

53. An apparatus as claimed in claim 52 wherein the sample container may comprise an array of discrete receptacles.

54. An apparatus as claimed in claim 51 wherein the receiving space for receiving a sample comprises a space for a plurality of sample containers.

55. An apparatus as claimed in any one of claims 51 to 54 wherein the sample space for a fluid sample has a volume of not more than 1 ml.

56. A holder for a sample container for a fluid sample, which container comprises a support, a receptacle which, together with the support, defines a sample space, and heater means affixed to said support, said holder comprising control means operable so as to apply a voltage across, or supply current to, the electrically resistive element in such a fashion that the electrically resistive element may serve as a heater in a first period and may serve as temperature sensing means in a second period.

57. A holder as claimed in claim 56 wherein the container comprises a support, an array of discrete receptacles which, together with the support defines an array of sample spaces each arranged to receive a sample of fluid, and heater means affixed to said support, wherein said holdercomprises control means operable so as to apply a voltage across, or supply current to, the or each electrically resistive element in such a fashion that the or each electrically resistive element may serve as a heater in a first period and may serve as temperature sensing means in a second period.

58. A holder as claimed in claim 57 wherein the control means and the or each electrically resistive element are so arranged that the element(s) may apply to one or more receptacles of the array heating conditions that are different from those applied to another receptacle or receptacles of the array.

59. A holder as claimed in claim 58 comprising a multiplicity of elements and a multiplicity of connectors to the elements.

60. A holder as claimed in any one of claims 54 to 57 comprising a container having the features defined in the respective claim.

61. A sample container substantially as described herein with reference to the description and any of FIGS. 1 to 11.
